(19) United States
(12) Patent Application Publication
(10) Pub. No.: US 2026/0234872 A1
(43) Pub. Date: Aug. 13, 2026

(54) PACKING MATERIAL AND MANUFACTURING METHOD OF PACKING MATERIAL

(71) Applicant: SONY GROUP CORPORATION, TOKYO (JP)

(72) Inventors: YUUKO MOTOYAMA, TOKYO (JP); TAKAYUKI YAGI, TOKYO (JP); MITSUHIRO OKAMOTO, TOKYO (JP); SATOSHI AWATSUJI, TOKYO (JP); JUNKO KATSURAKU, TOKYO (JP); SEIJI YAMADA, TOKYO (JP); YASUTOSHI KAWATE, TOKYO (JP); NAOTO MORINAGA, TOKYO (JP); TOMONORI WATANABE, TOKYO (JP); JUN NISHIMURA, TOKYO (JP)

(21) Appl. No.: 19/154,183

(22) PCT Filed: Jan. 31, 2024
(86) PCT No.: PCT/JP2024/003029

§ 371 Date: Aug. 6, 2025

(30) Foreign Application Priority Data
Feb. 15, 2023 (JP) 2023-021877

(51) Int. Cl. D21H 17/00; B32B 1/00; B32B 3/12; B32B 5/02; B32B 5/18; B32B 5/20; B32B 5/24; B32B 7/12; B32B 29/00; B32B 29/06; B32B 29/08; D21F 11/00; D21H 17/06; D21H 17/15; D21H 17/36; D21H 17/53; D21H 17/66; D21H 21/06; D21H 21/22; D21H 21/36; D21H 27/32

(52) U.S. Cl. CPC D21H 17/74; B32B 1/00; B32B 3/12; B32B 5/02; B32B 5/18; B32B 5/20; B32B 5/245; B32B 7/12; B32B 29/007; B32B 29/06; B32B 29/08; D21F 11/002; D21H 17/06; D21H 17/15; D21H 17/36; D21H 17/53; D21H 17/66; D21H 21/06; D21H 21/22; D21H 21/36; D21H 27/32; B32B 2250/26; B32B 2250/44; B32B 2307/102; B32B 2307/304; B32B 2307/3065; B32B 2307/56; B32B 2553/02

(57) ABSTRACT

A main object is to provide a technology that can manipulate occurrence of “migration” from a foam material to an object in contact therewith. The present technology provides a paper foam material including a fibrous material containing waste paper and/or pulp, a binder, sodium hydrogen carbonate, a surfactant, a water-soluble softener, and carboxylic anhydride having a saturated hydrocarbon group and/or an unsaturated hydrocarbon group. The paper foam material according to the present technology can be used for one or more applications selected from cushioning material use, packing material use, sound absorbing material use, heat insulating material use, and flame-proof material use.

### TECHNICAL FIELD

The present technology relates to a packing material and a manufacturing method of the packing material.

### BACKGROUND ART

Conventionally, many cushioning materials used for transportation of office automation (OA) equipment, home electric appliances, and the like include a synthetic resin material. Examples thereof include synthetic resin products such as styrene foam, a highly expanded polyethylene sheet, polyethylene foam, and bubble wrap.

On the other hand, a cushioning material using an environmentally friendly recyclable material as a raw material is required worldwide. Examples of the recyclable cushioning material include a cushioning material using paper, but a cushioning material using paper as a raw material has a problem that physical properties such as durability, elasticity, and restoring force are inferior to those of a cushioning material using a synthetic resin material as a raw material.

Under such circumstances, in recent years, a technique for improving physical properties of a cushioning material using recyclable paper as a raw material has been developed. For example, Patent Document 1 discloses a light and elastic cushioning material including a molded foam obtained by mixing a paper component and a binder containing gelatin or alginic acid by an amount of 50 wt % or more.

Furthermore, Patent Document 2 discloses a molded foam in which generation of crater-shaped dents is reduced and elastic performance is excellent, the molded foam being obtained by kneading a fibrous material with an aqueous solution dissolved with a binder mainly composed of a gelatin having a jelly strength of 130 Bloom or more and/or animal glue and foaming and molding the mixture.

### CITATION LIST

### Patent Document

Patent Document 1: Japanese Patent Application Laid-Open No. H10-152173
Patent Document 2: Japanese Patent Application Laid-Open No. 2002-293980

### SUMMARY OF THE INVENTION

### Problems to be Solved by the Invention

As described above, as a technique for improving the physical properties of a cushioning material using recyclable paper or the like as a raw material, a foam material using paper or the like as a raw material and having excellent elasticity has been developed, but there is an actual situation in which further improvement is expected. For example, when a conventional foam material using paper as a raw material is stored in a state of being in contact with, for example, a resin, a metal, or the like, there is a problem that so-called “migration” occurs in which a chemical oozes out from the foam material and discoloration occurs in the object in contact such as the resin, the metal, or the like due to the chemical oozing out. In a case where a foam material that causes the migration is used as a cushioning material for packing a product, a mark of the cushioning material remains at a portion where the product and the cushioning material are in close contact with each other, and in this case, the product becomes a foreign matter-adhered defective product.

Furthermore, in a case where a packing material having a hybrid configuration is formed by combining a foam material that causes the migration with another cushioning material, there is a problem that cushioning characteristics of the cushioning material is deteriorated due to the migration of a component of the foam material to another cushioning material.

Accordingly, a main object of the present technology is to provide a technique that can manipulate occurrence of “migration” from a foam material to an object in contact therewith.

### Solutions to Problems

That is, firstly, the present technology provides a paper foam material including a fibrous material containing waste paper and/or pulp,
a binder,
sodium hydrogen carbonate,
a surfactant,
a water-soluble softener, and
carboxylic anhydride having a saturated hydrocarbon group and/or an unsaturated hydrocarbon group.

In the paper foam material according to the present technology, the carboxylic anhydride can have a molar ratio of 0.01 to 2 with respect to the softener.

In the paper foam material according to the present technology, the saturated hydrocarbon group and/or the unsaturated hydrocarbon group can have a number of carbon atoms of 12 to 24.

In the paper foam material according to the present technology, the carboxylic anhydride can include alkenyl carboxylic anhydride. In this case, as the alkenyl carboxylic anhydride, octadecenyl carboxylic anhydride can be used. Moreover, in this case, as the octadecenyl carboxylic anhydride, octadecenyl succinic anhydride can be used.

In the paper foam material according to the present technology, as the softener, polyhydric alcohol can be used.

The paper foam material according to the present technology can include an anti-tarnishing agent. In this case, the anti-tarnishing agent can contain alum.

The paper foam material according to the present technology can include an antibacterial agent. In this case, the antibacterial agent can contain potassium sorbate.

In the paper foam material according to the present technology, the binder can contain polyvinyl alcohol.

In the paper foam material according to the present technology, the surfactant can contain polyoxyethylene alkyl ether.

The paper foam material according to the present technology can have a sheet shape subjected to one or more processing selected from embossing, indenting processing, protruding processing, and hollow processing.

The paper foam material according to the present technology can be bonded to a base material with an adhesive layer interposed between the paper foam material and the base material.

The paper foam material according to the present technology can be used for one or more applications selected from cushioning material use, packing material use, sound absorbing material use, heat insulating material use, and flame-proof material use.

Next, the present technology provides a manufacturing method of a paper foam material, the manufacturing method including: a mixing step of mixing a composition including
a fibrous material containing waste paper and/or pulp,
a binder,
sodium hydrogen carbonate, and
a surfactant, and containing
a water-soluble softener, and
carboxylic anhydride having a saturated hydrocarbon group and/or an unsaturated hydrocarbon group; and
a foaming step of foaming the composition.

The manufacturing method according to the present technology can further perform a molding step of molding the composition by using a mold and/or an embossed sheet.

The manufacturing method according to the present technology can further perform a drying step of drying the composition after foaming.

The manufacturing method according to the present technology can further perform a laminating step of laminating the composition after drying on the composition after foaming. In this case, the manufacturing method can further perform, before the laminating step, a moisture adding step of moistening the composition after drying with a liquid.

### BRIEF DESCRIPTION OF DRAWINGS

FIG. 1 is a drawing-substituting photograph showing an example of a sound absorbing material 100 or a heat insulating material 200 according to the present technology.

FIG. 2 is a drawing-substituting photograph showing an example, different from that in FIG. 1, of the sound absorbing material 100 or the heat insulating material 200 according to the present technology.

FIG. 3 is a flowchart of a first embodiment of a manufacturing method of a paper foam material 1 used in the present technology.

FIG. 4 is a flowchart of a second embodiment of a manufacturing method of a paper foam material 1 used in the present technology.

FIG. 5 is a drawing-substituting photograph showing an example of a form of a foam material 1 used in the present technology.

FIG. 6 is a cross-sectional view of the foam material 1 shown in FIG. 5.

FIG. 7 is a schematic view illustrating an example of a form of the foam material 1 used in the present technology.

FIG. 8 is a schematic view illustrating an example, different from that in FIG. 7, of a form of the foam material 1 used in the present technology.

FIG. 9 is a drawing-substituting photograph showing an example, different from those in FIGS. 7 and 8, of a form of the foam material 1 used in the present technology.

FIG. 10 is a drawing-substituting photograph showing an example, different from those in FIGS. 7 to 9, of a form of the foam material 1 used in the present technology.

FIG. 11 is a drawing-substituting photograph showing an example, different from those in FIGS. 7 to 10, of a form of the foam material 1 used in the present technology.

FIG. 12 is a schematic view illustrating an example of a first embodiment or a second embodiment of a manufacturing method of the foam material 1 used in the present technology.

FIG. 13 is a schematic view illustrating an example, different from that in FIG. 12, of the manufacturing method of the foam material 1 used in the present technology.

FIG. 14 is a schematic view illustrating an example, different from those in FIGS. 12 and 13, of the manufacturing method of the foam material 1 used in the present technology.

FIG. 15 is a schematic view illustrating an example, different from those in FIGS. 12, 13, and 14, of the manufacturing method of the foam material 1 used in the present technology.

FIG. 16 is a flowchart of a third embodiment of a manufacturing method of a paper foam material 1 used in the present technology.

FIG. 17 is a schematic view illustrating an example of the third embodiment of the manufacturing method of the foam material 1 used in the present technology.

FIG. 18 is a schematic view illustrating an example, different from that in FIG. 17, of the manufacturing method of the foam material 1 used in the present technology.

FIG. 19 is a flowchart of a fourth embodiment of a manufacturing method of a foam material 1 used in the present technology.

FIG. 20 is a drawing-substituting photograph showing an example of a composite material 2 used in the present technology.

FIG. 21 is a drawing-substituting photograph showing an example of the composite material 2, different from that in FIG. 20, used in the present technology.

FIG. 22 is a flowchart of a first embodiment of a manufacturing method of the composite material 2 used in the present technology.

FIG. 23 is a schematic view illustrating an example of the manufacturing method of the composite material 2 according the present technology.

FIG. 24 is a schematic view illustrating an example, different from that in FIG. 23, of the manufacturing method of the composite material 2 according the present technology.

FIG. 25 is a schematic view illustrating an example, different from those in FIGS. 23 and 24, of the manufacturing method of the composite material 2 according the present technology.

FIG. 26 is a schematic view illustrating a first embodiment of a multilayer structure 3 used in the present technology.

FIG. 27 is a schematic view illustrating a second embodiment of a multilayer structure 3 used in the present technology.

FIG. 28 is a schematic view illustrating a third embodiment of a multilayer structure 3 used in the present technology.

FIG. 29 is a schematic view illustrating a fourth embodiment of a multilayer structure 3 used in the present technology.

FIG. 30 is a schematic view illustrating a fifth embodiment of a multilayer structure 3 used in the present technology.

FIG. 31 is a schematic view illustrating a sixth embodiment of a multilayer structure 3 used in the present technology.

FIG. 32 is a flowchart of a first embodiment of a manufacturing method of a multilayer structure 3 used in the present technology.

FIG. 33 is a graph showing results of a sound absorption test of Experimental example 4.

FIG. 34 is a drawing-substituting photograph of an aromatic material/deodorant material manufactured in Experimental example 7.

FIG. 35 is a drawing-substituting photograph showing a result of performing coloring processing on the paper foam material according to the present technology in Experimental example 8.

FIG. 36 is a drawing-substituting photograph of a composite material manufactured in Experimental example 9.

FIG. 37 is a drawing-substituting photograph showing the steps of recycling the paper foam material according to the present technology in Experimental example 10.

FIG. 38 is a drawing-substituting photograph showing a result of performing soil reduction on the paper foam material according to the present technology in Experimental example 11.

FIG. 39 is a drawing-substituting photograph showing a result of growing a plant in Experimental example 11.

FIG. 40 is a drawing-substituting photograph showing a result of growing a plant by hydroponic cultivation in Experimental example 11.

FIG. 41 is a drawing-substituting photograph showing a result of growing a plant by mushroom bed cultivation in Experimental example 11.

### MODE FOR CARRYING OUT THE INVENTION

Hereinafter, preferred embodiments for carrying out the present technology will be described with reference to the drawings.

The embodiments to be described below are intended to illustrate examples of representative embodiments of the present technology. Therefore, the scope of the present technology will not be construed narrower by these embodiments. Note that the description will be given in the following order.
1. Paper foam material 1
(1) Fibrous material
(2) Binder
(3) Foam accelerator
(4) Surfactant
(5) Water-soluble softener
(6) Carboxylic anhydride having saturated hydrocarbon group and/or unsaturated hydrocarbon group
(7) Anti-tarnishing agent
(8) Antibacterial agent
(9) Other components
(10) Specific gravity
(11) Application of paper foam material 1
2. Manufacturing method of paper foam material 1
[First Embodiment, Second Embodiment]
(1) Defibration treatment step S1
(2) Binder mixing step S2
(3) Mixing step S3
(4) Foaming step S4
(5) Molding step S5
(6) Drying step S6
[Third Embodiment]
(7) Moisture adding step S7
(8) Laminating step S8 (First laminating step)
[Fourth Embodiment]
(9) Applying step S9
(10) Laminating step S10 (Second laminating step)
(11) Drying step S11
3. Composite material 2
(1) Base material 21
(2) Application of composite material 2
4. Manufacturing method of composite material 2
(1) Attaching step S12
(2) Drying step S13
5. Multilayer structure 3
(1) Adhesive layer 32
(2) Form of multilayer structure 3
(3) Application of multilayer structure 3
6. Manufacturing method of laminated structure 3
(1) Adhesive applying step S14
(2) Laminating step S15 (Third laminating step)
(3) Drying step S16
(4) Molding step S17

### 1. Paper Foam Material 1

A paper foam material 1 used for the present technology contains a fibrous material, a binder, a foam accelerator, a surfactant, a water-soluble softener, and carboxylic anhydride having a saturated hydrocarbon group and/or an unsaturated hydrocarbon group. Furthermore, if necessary, the paper foam material 1 can contain other components such as an anti-tarnishing agent and an antibacterial agent. Hereinafter, each component is described in detail.

### (1) Fibrous Material

As the fibrous material used for the paper foam material 1 used in the present technology, one or two types or more of fibrous materials that can be used for the paper foam material can be freely selected and used as long as the effects of the present technology are not impaired. Examples of the fibrous material include waste paper such as newspaper, magazines, books, and corrugated cardboard, pulp (such as bamboos, bagasse, and straw), and the like. Among these materials, in the present technology, it is preferable to use waste paper such as newspaper, magazines, books, and corrugated cardboard from the viewpoint of being recyclable. Furthermore, the material can also be used in combination with other fibrous materials (for example, cotton fabrics, wool fabrics, glass fibers, chemical fibers, and the like).

More specifically, a fibrous material containing waste paper and/or pulp is preferably used for the paper foam material 1 used in the present technology. By using the fibrous material containing waste paper and/or pulp, recyclability can be improved. The waste paper can include, for example, newspaper, magazines, books, corrugated cardboard, and the like as described above. The pulp can include wood, non-wood, and the like. Examples of the non-wood can include bamboo, bagasse, straw, and the like.

The length of the fibrous material used in the present technology can be freely set as long as the effects of the present technology are not impaired, but for example, a fibrous material defibrated to a length of 0.3 to 1.2 mm, preferably 0.3 to 1.0 mm, more preferably 0.5 to 1.0 mm can be used.

### (2) Binder

As the binder used for the paper foam material 1 used in the present technology, one or two types or more of binders that can be used for the paper foam material can be freely selected and used as long as the effects of the present technology are not impaired. Examples of the binder include polyvinyl alcohol, polyethylene glycol, polyethylene succinate, polybutylene succinate, polybutylene succinate adipate, polycaprolactone, polylactic acid, gum arabic, polysaccharides (for example, carboxymethyl cellulose, hydroxypropyl cellulose, hydroxyethyl cellulose, methyl cellulose, cellulose acetate, starch, carrageenan, xanthan gum, agar, guar gum, tara gum, locust bean gum, glucomannan, gum arabic, gellan gum, alginic acid, pectin, and the like), proteins (for example, casein, gelatin, animal glue, albumen, and the like), and the like. Among these binders, one or two types or more of binders are preferably selected from polysaccharides and proteins from the viewpoint of a high degree of contribution to the environment.

The viscosity of the binder aqueous solution used for the paper foam material 1 used in the present technology is not particularly limited as long as the effects of the present technology are not impaired, but for example, it is preferable to use a binder aqueous solution having a static viscosity of 50 mPa/s or more at room temperature (25° C.), and it is more preferable to use a binder aqueous solution having a static viscosity of 220 mPa/s or more at room temperature. By using the binder aqueous solution having a lower limit value of the static viscosity in the above range, foamability in a mixing step S3 of the materials in the manufacturing method of the paper foam material 1 described later can be improved.

Furthermore, for example, it is preferable to use a binder aqueous solution having a static viscosity of 450 mPa/s or less at room temperature, and it is more preferable to use a binder aqueous solution having a static viscosity of 240 mPa/s or less at room temperature. By using the binder aqueous solution having an upper limit value of the static viscosity in the above range, workability in a foaming step S4 of the materials in the manufacturing method of the paper foam material 1 described later can be improved.

Note that, in the present technology, the static viscosity is a value measured by using a vibratory viscometer VM-100A (manufactured by SEKONIC CORPORATION).

The structure of the binder used in the paper foam material 1 used in the present technology is not particularly limited as long as the effects of the present technology are not impaired, but it is preferable that the ratio of functional groups having low polarity is small with respect to the number of all functional groups. By using the binder in which the ratio of functional groups having low polarity is small, foamability in the foaming step S4 of the materials in the manufacturing method of the paper foam material 1 described later can be improved. Specifically, a binder in which a ratio of functional groups having high polarity is 6.7 to 23.3% is preferably used.

More specifically, for example, in a case where carboxymethyl cellulose which is a polysaccharide is used as the binder, the carboxymethyl cellulose has a hydroxyl group (—OH) and a carboxymethyl group (—CH₂COO—), and the relationship between the polarities of these functional groups is hydroxyl group (—OH)<carboxymethyl group (—CH₂COO—). Therefore, in the present technology, in a case where carboxymethyl cellulose is used as the binder, it is preferable to use carboxymethyl cellulose having a small ratio of carboxymethyl groups (—CH₂COO—), that is, a low degree of etherification (a degree of substitution (DS) value). As a specific value, in the present technology, in a case where carboxymethyl cellulose is used as the binder, it is preferable to use carboxymethyl cellulose having a degree of etherification (DS value) of 0.2 to 0.7.

Furthermore, for example, in a case where hydroxypropyl cellulose or hydroxyethyl cellulose which is a polysaccharide is used as the binder, a hydroxyl group (—OH), a hydroxypropyl group (—CH₂C(OH)HCH₃), and a hydroxyethyl group (—CH₂CH₂OH) exist in hydroxypropyl cellulose or hydroxyethyl cellulose, and the relationship between the polarities of these functional groups is hydroxyl group (—OH)>hydroxypropyl group (—CH₂C(OH)HCH₃), and hydroxyl group (—OH)>hydroxyethyl group (—CH₂CH₂OH). Therefore, in the present technology, in a case where hydroxypropyl cellulose or hydroxyethyl cellulose is used as the binder, it is preferable to use hydroxypropyl cellulose or hydroxyethyl cellulose having a small ratio of hydroxyl group (—OH). As a specific value, in the present technology, in a case where hydroxypropyl cellulose or hydroxyethyl cellulose is used as the binder, it is preferable to use hydroxypropyl cellulose or hydroxyethyl cellulose having a ratio of hydroxyl group (—OH) of 6.7 to 23.3%.

The content of the binder in the paper foam material 1 used in the present technology is not particularly limited as long as the effects of the present technology are not impaired, but it is preferable that the binder is contained by 3 to 100 parts by mass and more preferably 7 to 70 parts by mass with respect to 100 parts by mass of the fibrous material.

The concentration of the binder aqueous solution used for the paper foam material 1 used in the present technology is not particularly limited as long as the effects of the present technology are not impaired, but for example, it is preferable to use a binder aqueous solution of 1 mass % or more, and it is more preferable to use a binder aqueous solution of 2 mass % or more. By using the binder aqueous solution having a lower limit value of the concentration in this range, the strength of the paper foam material 1 to be manufactured can be improved.

Furthermore, for example, it is preferable to use a binder aqueous solution of 11 mass % or less, more preferably to use a binder aqueous solution of 7 mass % or less, and still more preferably to use a binder aqueous solution of 5 mass % or less. By using the binder aqueous solution having an upper limit value of the concentration in the above range, foamability in the foaming step S4 of the materials in the manufacturing method of the paper foam material 1 described later can be improved, and furthermore, a specific gravity of the paper foam material 1 to be manufactured can be reduced.

### (3) Foam Accelerator

As the foam accelerator used for the paper foam material 1 used in the present technology, one or two types or more of foam accelerators that can be used for the paper foam material can be freely selected and used as long as the effects of the present technology are not impaired. Examples of the foam accelerator include azo compounds such as azodicarbonamide (ADCA), nitroso compounds such as N,N′-dinitrosopentamethylenetetramine (DPT), hydrazine derivatives such as 4,4-oxybis(benzenesulfonylhydrazide) (OBSH) and hydrazodicarbonamide (HDCA), azo compounds such as barium azodicarboxylate (Ba/AC), bicarbonates such as sodium hydrogen carbonate (sodium bicarbonate), and the like. Among these substances, sodium hydrogen carbonate (sodium bicarbonate) is preferably used from the viewpoint of easy availability and economic efficiency.

In the present technology, by using sodium hydrogen carbonate (sodium bicarbonate) as the foam accelerator, the specific gravity of a paper foam material using a fibrous material containing waste paper and/or pulp can be reduced, and as a result, cushioning properties and the like can be improved.

The content of the foam accelerator in the paper foam material 1 used in the present technology is not particularly limited as long as the effects of the present technology are not impaired, but it is preferable that the foam accelerator is contained by 0.5 to 15 parts by mass and more preferably 1 to 10 parts by mass with respect to 100 parts by mass of the fibrous material.

### (4) Surfactant

As the surfactant used for the paper foam material 1 used in the present technology, one or two types or more of surfactants that can be used for the paper foam material can be freely selected and used as long as the effects of the present technology are not impaired. Examples of the surfactant include polyoxyethylene alkyl ether, sodium alkyl sulfate, alkyltrimethylammonium chloride, alkyldiaminoethylglycine chloride, and the like. Among these substances, polyoxyethylene alkyl ether is preferably used from the viewpoint of accelerating foaming.

The content of the surfactant in the paper foam material 1 used in the present technology is not particularly limited as long as the effects of the present technology are not impaired, but it is preferable that the surfactant is contained by 0.1 to 50 parts by mass and more preferably 10 to 30 parts by mass with respect to 100 parts by mass of the fibrous material.

The concentration of a surfactant aqueous solution used for the paper foam material 1 used in the present technology is not particularly limited as long as the effects of the present technology are not impaired, but for example, in the binder mixing step in the manufacturing method of the paper foam material 1 described later, the surfactant aqueous solution is prepared so that the concentration of the surfactant in the mixture of the binder and the surfactant aqueous solution is preferably 1 mass % or more, more preferably 3 mass % or more, and still more preferably 4 mass % or more. By preparing the surfactant having a lower limit value of the concentration in the above range, foamability in the foaming step S4 of the materials in the manufacturing method of the paper foam material 1 described later can be improved, and furthermore, the specific gravity of the paper foam material 1 to be manufactured can be reduced.

Furthermore, for example, in the binder mixing step in the manufacturing method of the paper foam material 1 described later, the surfactant aqueous solution is prepared so that the concentration of the surfactant in the mixture of the binder and the surfactant aqueous solution is preferably 20 mass % or less, more preferably 15 mass % or less, and still more preferably 10 mass % or less. By preparing the surfactant having an upper limit value of the concentration in the above range, foamability in the mixing step S3 of the materials in the manufacturing method of the paper foam material 1 described later can be improved.

### (5) Water-Soluble Softener

In the paper foam material 1 used in the present technology, the water-soluble softener is used. As the water-soluble softener used for the paper foam material 1 according to the present technology, one or two types or more of water-soluble softeners that can be used for the paper foam material can be freely selected and used as long as the effects of the present technology are not impaired. Examples of the water-soluble softener include: urea and urea derivatives; polyhydric alcohols such as glycerin, ethylene glycol, diethylene glycol, polyethylene glycol, polyvinyl alcohol, propylene glycol, and butylene glycol; saccharides such as sucrose and trehalose; sugar alcohols such as sorbitol; amines such as triethanolamine; and the like.

Incidentally, a softener for imparting elasticity is essential for a paper foam material using a fibrous material containing waste paper and/or pulp, and it has been common to use glycerin as a softener so far. However, when the paper foam material using glycerin is used as a cushioning material for a component using a resin, a metal, or the like for a long period of time, a “migration” phenomenon in which the component is discolored occurs in some cases. Although technologies for improving the “migration” phenomenon from the paper foam material have been developed so far, it has been difficult to apply the conventional technology for improving the “migration” phenomenon to the paper foam material using the fibrous material containing waste paper and/or pulp because a softener greatly affects the cushioning power of the paper foam material. Under such a background, the inventors of the present application have succeeded in reducing the occurrence of “migration” from the paper foam material 1 to an object in contact by using carboxylic anhydride having a saturated hydrocarbon group and/or an unsaturated hydrocarbon group to be described later even in a case where any softener is used.

Furthermore, in the present technology, it has been found that the occurrence of “migration” from the manufactured paper foam material 1 to the object in contact can be manipulated according to the type of water-soluble softener. That is, by using a specific softener, even in the paper foam material using the fibrous material containing waste paper and/or pulp, it has been successful to suppress the “migration” phenomenon while good cushioning properties are maintained.

In a case where the purpose is to reduce “migration”, it is preferable to use a softener having a weak hydrogen bonding strength in terms of its structure. The use of a softener having a structure with a weak hydrogen bonding strength can prevent the occurrence of “migration” due to hydrogen bonding. For example, because the relationship between the hydrogen bonding strengths is O—H>N—H, the occurrence of “migration” from the manufactured paper foam material 1 to the object in contact can be reduced by using a softener having an imino group (NH group) as compared with a softener having a hydroxyl group (OH group).

Furthermore, in the case of a chemical substance having a hydroxyl (OH) group, the lower the ratio of the number of hydroxyl (OH) groups to the number of carbon atoms is, the lower the hydrogen bonding strength is, and the occurrence of “migration” from the manufactured paper foam material 1 to the object in contact can be further reduced. Therefore, in a case where a polyhydric alcohol is used, it is preferable to use polyhydric alcohol in which the relationship between the number of carbon atoms in the molecular structure and the number of hydroxyl (OH) groups are the number of hydroxyl groups<the number of carbon atoms.

In view of the above, in order to reduce the occurrence of “migration” from the paper foam material 1 to the object in contact, among the softeners described above, it is preferable to use: urea and urea derivatives; among polyhydric alcohols with the number of carbon atoms of 3 to 15, propylene glycol and 1,3-butylene glycol; and sucrose and trehalose.

In a case where urea or urea derivatives is used, it is more preferable to use a urea derivative having a chemical structural formula of R¹,R²—N—CO—N—R³,R⁴ (R¹ to R⁴: H or a saturated and/or unsaturated hydrocarbon group with C of 1 to 4). This is because the urea derivative in which the number of carbon atoms of the saturated and/or unsaturated hydrocarbon group is 4 or less reliably exhibits water solubility.

The content of the water-soluble softener in the paper foam material 1 used in the present technology is not particularly limited as long as the effects of the present technology are not impaired, but it is preferable that the water-soluble softener is contained by 0.03 to 150 parts by mass and more preferably 0.05 to 100 parts by mass with respect to 100 parts by mass of the fibrous material.

(6) Carboxylic Anhydride Having Saturated Hydrocarbon Group and/or Unsaturated Hydrocarbon Group

The paper foam material 1 according to the present technology uses carboxylic anhydride having a saturated hydrocarbon group and/or an unsaturated hydrocarbon group. By using carboxylic anhydride having a saturated hydrocarbon group and/or an unsaturated hydrocarbon group, the occurrence of “migration” from the paper foam material 1 to the object in contact can be reduced even in a case where any softener is used.

For example, even in a case where polyhydric alcohol is used, in which “migration” occurs relatively easily among the water-soluble softeners mentioned above, the occurrence of “migration” from the paper foam material 1 to the object in contact can be reduced as shown in Examples described later by using carboxylic anhydride having a saturated hydrocarbon group and/or an unsaturated hydrocarbon group. As the mechanism of this, it can be inferred that oxygen derived from a carbonyl group of carboxylic anhydride having a saturated hydrocarbon group and/or an unsaturated hydrocarbon group reacts with a hydroxyl group present in the water-soluble softener such as polyhydric alcohol to suppress “migration”.

Examples of the saturated hydrocarbon group and/or the unsaturated hydrocarbon group of carboxylic anhydride used in the present technology include an alkyl group, an alkenyl group, and an alkynyl group, and it is preferable that the alkenyl group is used.

The number of carbon atoms of the saturated hydrocarbon group and/or the unsaturated hydrocarbon group of carboxylic anhydride used in the present technology is not particularly limited as long as the functions and effects of the present technology are not impaired. From the viewpoint of enhancing stability, the number of carbon atoms is preferably 12 to 24. Specifically, examples of the saturated and/or the unsaturated hydrocarbon group include a dodecenyl group, a tridecenyl group, a tetradecenyl group, a pentadecenyl group, a hexadecenyl group, a heptadecenyl group, an octadecenyl group, a nonadecenyl group, an icosenyl group, an eicosenyl group, a henicosenyl group, a heneicosenyl group, a docosenyl group, a tricosenyl group, and a tetracosenyl group, and it is preferable to use the octadecenyl group.

Carboxylic anhydride used in the present technology is not particularly limited as long as the functions and effects of the present technology are not impaired. Examples of the carboxylic anhydride include acetic anhydride, propionic anhydride, oxalic anhydride, succinic anhydride, maleic anhydride, phthalic anhydride, and benzoic anhydride, and it is preferable to use succinic anhydride.

The content of the carboxylic anhydride having the saturated hydrocarbon group and/or the unsaturated hydrocarbon group in the paper foam material 1 according to the present technology is not particularly limited as long as the functions and effects of the present technology are not impaired, but it is preferable to use carboxylic anhydride in a range of a molar ratio of 0.01 to 2, it is more preferable to use carboxylic anhydride in a range of a molar ratio of 0.06 to 1, and it is still more preferable to use carboxylic anhydride in a range of a molar ratio of 0.2 to 0.7 with respect to the softener.

### (7) Anti-Tarnishing Agent

In the paper foam material 1 used in the present technology, the anti-tarnishing agent can be used. As the anti-tarnishing agent used for the paper foam material 1 used in the present technology, one or two types or more of anti-tarnishing agents that can be used for the paper foam material can be freely selected and used as long as the effects of the present technology are not impaired. Examples of the anti-tarnishing agent include alum, magnesium, iron, copper, and the like. Among these substances, alum is preferably used from the viewpoint of easy availability and handling and economic efficiency.

The content of the anti-tarnishing agent in the paper foam material 1 used in the present technology is not particularly limited as long as the effects of the present technology are not impaired, but it is preferable that the anti-tarnishing agent is contained by 0.5 to 5 parts by mass and more preferably 1 to 3 parts by mass with respect to 100 parts by mass of the fibrous material.

### (8) Antibacterial Agent

In the paper foam material 1 used in the present technology, the antibacterial agent can be used. As the antibacterial agent used for the paper foam material 1 used in the present technology, one or two types or more of antibacterial agents that can be used for the paper foam material can be freely selected and used as long as the effects of the present technology are not impaired. Examples of the antibacterial agent include potassium sorbate, isopropyl methylphenol, salicylic acid, and the like. Among these substances, potassium sorbate is preferably used from the viewpoint of handling such as water solubility.

The content of the antibacterial agent in the paper foam material 1 used in the present technology is not particularly limited as long as the effects of the present technology are not impaired, but it is preferable that the antibacterial agent is contained by 0.1 to 1.5 parts by mass and more preferably 0.15 to 1 parts by mass with respect to 100 parts by mass of the fibrous material.

### (9) Other Components

As the paper foam material 1 used in the present technology, one or more types of other additives that can be used for the paper foam material can be freely selected and used as necessary. Examples of the additive include a crosslinking accelerator, a mold releasing agent, a pH adjuster, a pH buffer, an antifungal agent, a coloring agent, a bleaching agent, an antioxidant, a weather (light) resistant agent, a flame retardant, a filler, and the like.

### (10) Specific Gravity

The specific gravity of the paper foam material 1 used in the present technology can be freely set according to the application and purpose. The specific gravity of the paper foam material 1 used in the present technology is, for example, 0.3 to 0.5, preferably 0.3 to 0.4. Furthermore, the specific gravity of the foam mixture after the mixing step S3 of the materials in the manufacturing method of the paper foam material 1 described later is, for example, 0.3 to 0.5, preferably 0.3 to 0.4. Furthermore, the specific gravity of the mixture of the binder and the surfactant aqueous solution after a binder mixing step S2 in the manufacturing method of the paper foam material 1 described later is, for example, 0.2 to 0.7, preferably 0.2 to 0.35. By setting the specific gravity of the paper foam material 1, the foam mixture in the manufacturing step, and the mixture of the binder and the surfactant aqueous solution within the above ranges, impact resistance, restorability after impact, and the like can be further improved.

Note that, in the present technology, the specific gravity is a value measured in accordance with JIS Z8804.

### (11) Application of Paper Foam Material 1

The application of the paper foam material 1 used in the present technology described above is not particularly limited, and the paper foam material 1 can be suitably used for, for example, cushioning materials, packing materials, sound absorbing materials, sound insulating materials, sound-proof materials, vibration-proof materials, heat insulating materials, flame-proof materials, wallpaper, aromatic materials, deodorant materials, seat sheets for automobiles and the like, curing materials, agricultural materials, and the like.

Furthermore, if a recyclable material is used as the fibrous material described above, the application as a recycled material can also be expected. Hereinafter, specific examples will be described.

### [Sound Absorbing Material 100]

As the existing sound absorbing material, a petroleum-derived foaming material, glass wool, or the like is mainly used, but by using the paper foam material 1 according to the present technology as a sound absorbing material 100, the deplasticization rate can be improved in various scenes where sound absorption is required, such as wall surface interior, fittings, wall surfaces, ceilings, and various types of products.

Specifically, the present technology provides the sound absorbing material 100 containing
a fibrous material containing waste paper and/or pulp,
a binder,
sodium hydrogen carbonate, and
a surfactant, and containing
a water-soluble softener, and
carboxylic anhydride having a saturated hydrocarbon group and/or an unsaturated hydrocarbon group.

The sound absorbing material 100 according to the present technology can contain a porous material. Examples of the porous material include carbonized materials such as activated carbon, microporous materials such as zeolite, mesoporous materials such as mesoporous silica (MCM, FSM, and the like), macroporous materials such as pumice and coffee grounds, and the like.

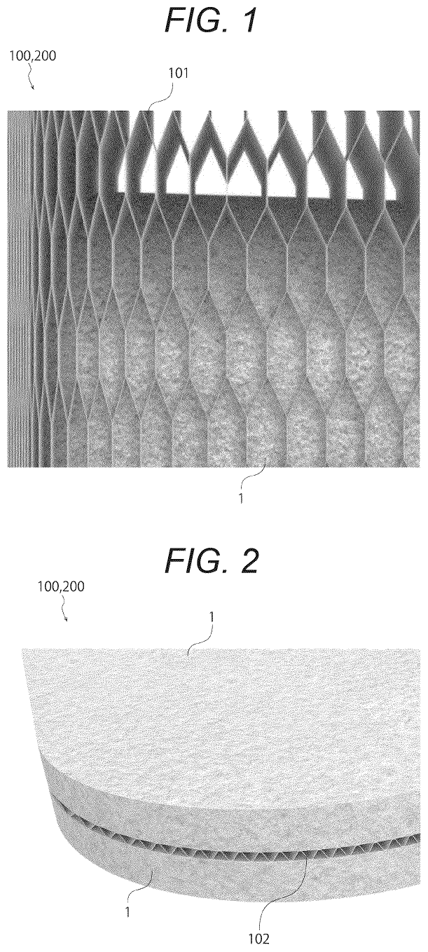

Furthermore, as illustrated in FIG. 1, the sound absorbing material 100 according to the present technology can have a structure in which a paper honeycomb structure is enclosed in the paper foam material 1. Furthermore, as illustrated in FIG. 2, the sound absorbing material 100 according to the present technology can have a structure in which the paper foam material 1 and a plate-shape corrugated cardboard 102 are laminated.

Note that the details of the fibrous material, the binder, the foam accelerator, the surfactant, the water-soluble softener, the carboxylic anhydride having a saturated hydrocarbon group and/or an unsaturated hydrocarbon group, the anti-tarnishing agent, the antibacterial agent, and other components that can be used for the sound absorbing material 100 according to the present technology are the same as those of the paper foam material 1 described above, and thus, the description thereof is herein omitted.

### [Heat Insulating Material 200]

As the existing heat insulating material, a petroleum-derived foaming material, glass wool, or the like is mainly used, but by using the paper foam material 1 according to the present technology as a heat insulating material 200, the deplasticization rate can be improved in various scenes where heat insulation is required, such as wall surface interior, fittings, wall surfaces, ceilings, and various types of products.

Specifically, the present technology provides the heat insulating material 200 containing
a fibrous material containing waste paper and/or pulp,
a binder,
sodium hydrogen carbonate, and
a surfactant, and containing
a water-soluble softener, and
carboxylic anhydride having a saturated hydrocarbon group and/or an unsaturated hydrocarbon group.

The heat insulating material 200 according to the present technology can adjust the heat insulating effect by changing the density of the paper foam material 1 by adjusting the foaming ratio of the paper foam material 1 to be used without increasing the thickness thereof.

Furthermore, as illustrated in FIG. 1, the heat insulating material 200 according to the present technology can have a structure in which a paper honeycomb structure is enclosed in the paper foam material 1. Furthermore, as illustrated in FIG. 2, the sound absorbing material 100 according to the present technology can have a structure in which the paper foam material 1 and a plate-shape corrugated cardboard 102 are laminated.

Note that the details of the fibrous material, the binder, the foam accelerator, the surfactant, the water-soluble softener, the carboxylic anhydride having a saturated hydrocarbon group and/or an unsaturated hydrocarbon group, the anti-tarnishing agent, the antibacterial agent, and other components that can be used for the heat insulating material 200 according to the present technology are the same as those of the paper foam material 1 described above, and thus, the description thereof is herein omitted.

### [Flame-Proof Material 300]

The paper foam material 1 according to the present technology can be used as a flame-proof material 300 in a case where the flame retardant effect is required by various regulations in various scenes such as in indoor interiors. In a case where the paper foam material 1 according to the present technology is used as the flame-proof material 300, a flame-proofing agent having the flame-proofing effect is preferably used for the paper foam material 1 according to the present technology.

Specifically, the present technology provides the flame-proof material 300 containing
a fibrous material containing waste paper and/or pulp,
a binder,
sodium hydrogen carbonate, and
a surfactant, and containing
a water-soluble softener,
carboxylic anhydride having a saturated hydrocarbon group and/or an unsaturated hydrocarbon group, and
a flame-proofing agent.

Examples of the flame-proofing agent that can be used for the flame-proof material 300 according to the present technology include aluminum hydroxide, magnesium silicate, alumina, ceramics, silica, boron, boric acid, and the like, and it is preferable to use aluminum hydroxide.

The content of the flame-proofing agent in the flame-proof material 300 according to the present technology is not particularly limited as long as the effects of the present technology are not impaired, but it is preferable that the flame-proofing agent is contained by, for example, 2 to 500 parts by mass, more preferably 50 to 300 parts by mass, and still more preferably 80 to 250 parts by mass with respect to 100 parts by mass of the fibrous material according to the type of the flame-proofing agent and the flame-proofing effect.

Note that the details of the fibrous material, the binder, the foam accelerator, the surfactant, the water-soluble softener, the carboxylic anhydride having a saturated hydrocarbon group and/or an unsaturated hydrocarbon group, the anti-tarnishing agent, the antibacterial agent, and other components that can be used for the flame-proof material 300 according to the present technology are the same as those of the paper foam material 1 described above, and thus, the description thereof is herein omitted.

### [Aromatic Material/Deodorant Material 400]

The paper foam material 1 according to the present technology can be used as an aromatic material/deodorant material 400 that is subjected to an aromatic/deodorant treatment to provide various scenes with functions based on aroma such as coloring, harmony, and signature. In a case where the paper foam material 1 according to the present technology is used as the aromatic material/deodorant material 400, an aromatic and/or a deodorant having the aromatic/deodorant effect is preferably used for the paper foam material 1 according to the present technology.

Specifically, the present technology provides the aromatic material and/or deodorant material 400 containing
a fibrous material containing waste paper and/or pulp,
a binder,
sodium hydrogen carbonate, and
a surfactant, and containing
a water-soluble softener,
carboxylic anhydride having a saturated hydrocarbon group and/or an unsaturated hydrocarbon group, and
aromatic and/or a deodorant.

Examples of the aromatic and/or the deodorant that can be used for the aromatic material/deodorant material 400 according to the present technology include a compost material, a carbonized material such as triporous or activated carbon, coffee grounds, tea grounds, a dry flower, and the like.

Note that the details of the fibrous material, the binder, the foam accelerator, the surfactant, the water-soluble softener, the carboxylic anhydride having a saturated hydrocarbon group and/or an unsaturated hydrocarbon group, the anti-tarnishing agent, the antibacterial agent, and other components that can be used for the aromatic material/deodorant material 400 according to the present technology are the same as those of the paper foam material 1 described above, and thus, the description thereof is herein omitted.

### 2. Manufacturing Method of Paper Foam Material 1

Because the paper foam material 1 according to the present technology has a novel composition, a manufacturing method thereof is not particularly limited, but as a suitable method, the paper foam material 1 can be manufactured by the manufacturing method according to the present technology described below. The manufacturing method of the paper foam material 1 used in the present technology can perform at least the mixing step S3 and the foaming step S4. Furthermore, if necessary, a defibration treatment step S1, the binder mixing step S2, a molding step S5, a drying step S6, an applying step S9, a moisture adding step S8, a laminating step S10, a drying step S11, and the like can also be performed. Hereinafter, each step is described in detail in time series.

### First Embodiment, Second Embodiment

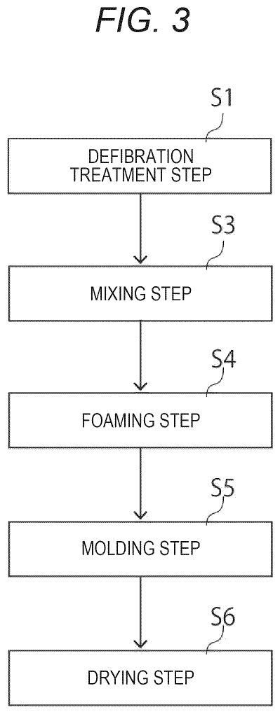

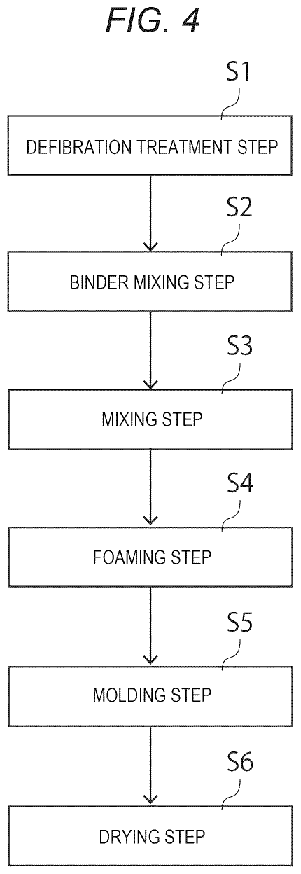

FIG. 3 is a flowchart of a first embodiment of a manufacturing method of the paper foam material 1 used in the present technology. FIG. 4 is a flowchart of a second embodiment of a manufacturing method of the paper foam material 1 used in the present technology.

### (1) Defibration Treatment Step S1

The defibration treatment step S1 is a step of defibrating a fibrous material to be a raw material of the paper foam material 1 used in the present technology. Note that, in a case where an already defibrated fibrous material is used, the defibration treatment step S1 is not essential.

In the present technology, as the method of defibration treatment, one or a combination of two or more of general defibration treatment methods can be used as long as the effects of the present technology are not impaired. For example, either a wet defibration method or a dry defibration method can be used. Specific methods of defibration can be freely combined and used according to the type of raw materials, such as cutting, crushing, crushing, impact crushing, and ultrasonic crushing.

### (2) Binder Mixing Step S2

The binder mixing step S2 is a step of mixing a binder with an aqueous solution containing a surfactant (see the second embodiment illustrated in FIG. 4). The paper foam material 1 used in the present technology can be produced even if all the materials are mixed in the mixing step S3 described later without performing the binder mixing step S2. However, in a case where a binder containing one or more selected from polysaccharides and proteins is used as the binder, the binder mixing step S2 is preferably performed. By performing the binder mixing step S2, the binder and the surfactant in the aqueous solution can be efficiently and sufficiently mixed.

### (3) Mixing Step S3

The mixing step S3 is a step of mixing various types of components used for the paper foam material 1 according to the present technology. Specifically, the mixing step is a step of mixing the fibrous material, the binder, the foam accelerator, the surfactant, the water-soluble softener, and carboxylic anhydride having a saturated hydrocarbon group and/or an unsaturated hydrocarbon group, and as necessary, other components such as the anti-tarnishing agent and the antibacterial agent.

Note that the mixing step S3 can be performed simultaneously in the foaming step S4 described later. That is, foaming may be performed simultaneously with the mixing of the various types of components.

### (4) Foaming Step S4

The foaming step S4 is a step of making the mixture of the various types of components used for the paper foam material 1 according to the present technology foam. Specifically, the foaming step is a step of making the mixture foam, the mixture containing the fibrous material, the binder, the foam accelerator, the surfactant, the water-soluble softener, and carboxylic anhydride having a saturated hydrocarbon group and/or an unsaturated hydrocarbon group, and as necessary, other components such as the anti-tarnishing agent and the antibacterial agent.

The foaming method in the foaming step S4 can be performed by one or a combination of two or more of general foaming methods as long as the effects of the present technology are not impaired. Examples of the foaming method include a method of foaming the mixture while stirring and mixing the mixture, a method of foaming the mixture by forcibly sending a gas into the mixture, a method of foaming the mixture by adding a foaming agent or the like to the mixture, and the like.

Specifically, for example, in the mixing step S3, a composition containing various types of components used for the paper foam material 1 used in the present technology can be mixed at a first rotation speed. Specifically, in the mixing step S3, the composition can be mixed at the first rotation speed, the composition containing the fibrous material, the binder, sodium hydrogen carbonate, the surfactant, the water-soluble softener, and carboxylic anhydride having a saturated hydrocarbon group and/or an unsaturated hydrocarbon group, and as necessary, other components such as the anti-tarnishing agent and the antibacterial agent.

Note that, the mixing step S3 also includes a case where the foaming occurs simultaneously with the mixing of the composition containing various types of components. That is, in the mixing step S3, foaming can be started while the composition is mixed at the first rotation speed, and moreover, in the foaming step S4, foaming can be further performed while the composition is mixed at a second rotation speed.

In the foaming step S4, the composition containing various types of components used in the present technology can be foamed at the second rotation speed higher than the first rotation speed. More specifically, the foaming step S4 is a step of making the composition foam at the second rotation speed higher than the first rotation speed, the composition containing the fibrous material, the binder, sodium hydrogen carbonate, the surfactant, the water-soluble softener, and carboxylic anhydride having a saturated hydrocarbon group and/or an unsaturated hydrocarbon group, and as necessary, other components such as the anti-tarnishing agent and the antibacterial agent.

In order to reduce the specific gravity of a paper foam material using a fibrous material containing waste paper and/or pulp for the purpose of improving the cushioning properties and the like, at the time of mixing materials to be used for the paper foam material, each material has been separately introduced, it has been devised to change the rotation speed for mixing and to gradually mix the materials, or the like, which has been making the manufacturing process become complicated. On the other hand, the inventors of the present application have succeeded in producing a paper foam material having excellent cushioning properties and a small specific gravity by using sodium hydrogen carbonate (sodium bicarbonate) as a foam accelerator and mixing each of the materials together in one stage without changing the rotation speed.

### (5) Molding Step S5

The molding step S5 is a step of molding the composition into a desired shape. The molding method in the molding step S5 can be performed by one or a combination of two or more of general molding methods as long as the effects of the present technology are not impaired. Examples of the molding method include injection molding, extrusion molding, press molding, blow molding, calendar molding, casting molding, and the like.

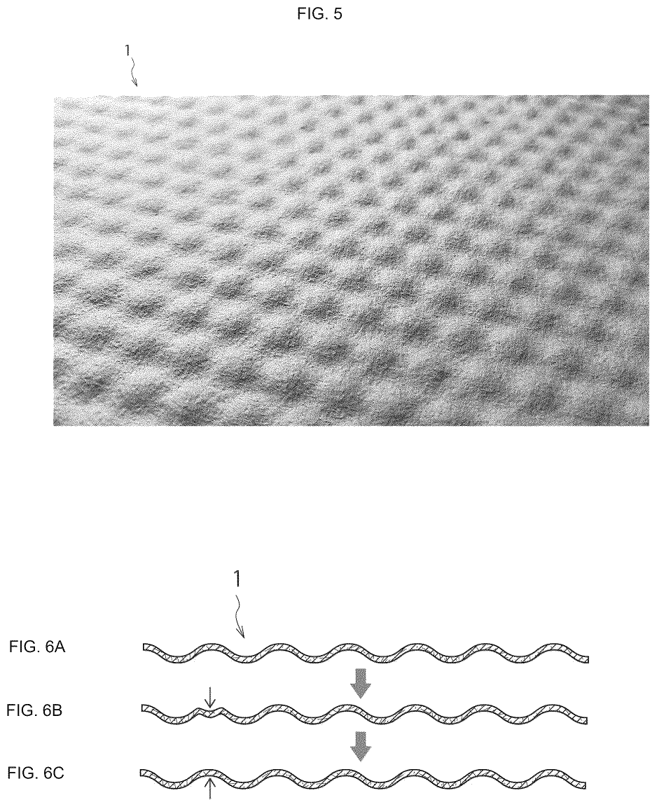

The specific shape to be molded in the molding step S5 is not particularly limited, and can be freely designed according to the application and the like of the paper foam material 1 to be manufactured. For example, the paper foam material can be formed into a sheet shape subjected to embossing as illustrated in FIG. 5. By being subjected to embossing, for example, as illustrated in FIG. 6, even if a dent is generated in a part (see FIG. 6B), the dent is restored by the restoring force (see FIG. 6C), and the paper foam material can be suitably used as a cushioning material or a packing material.

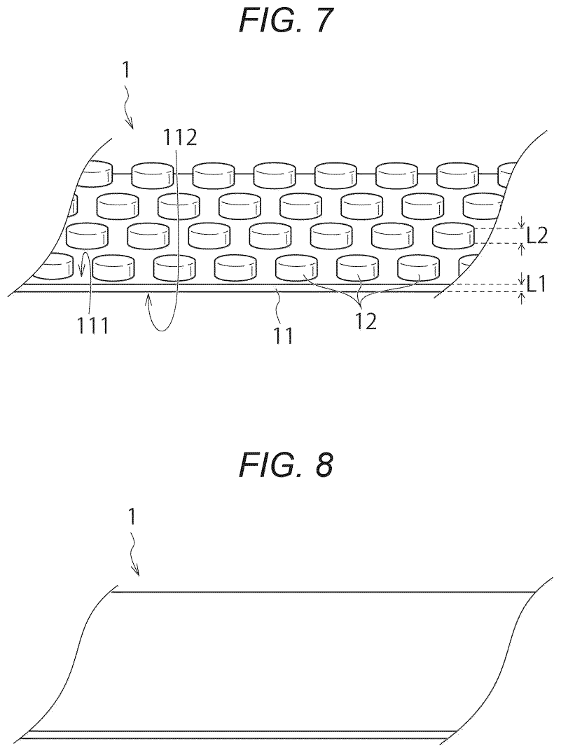

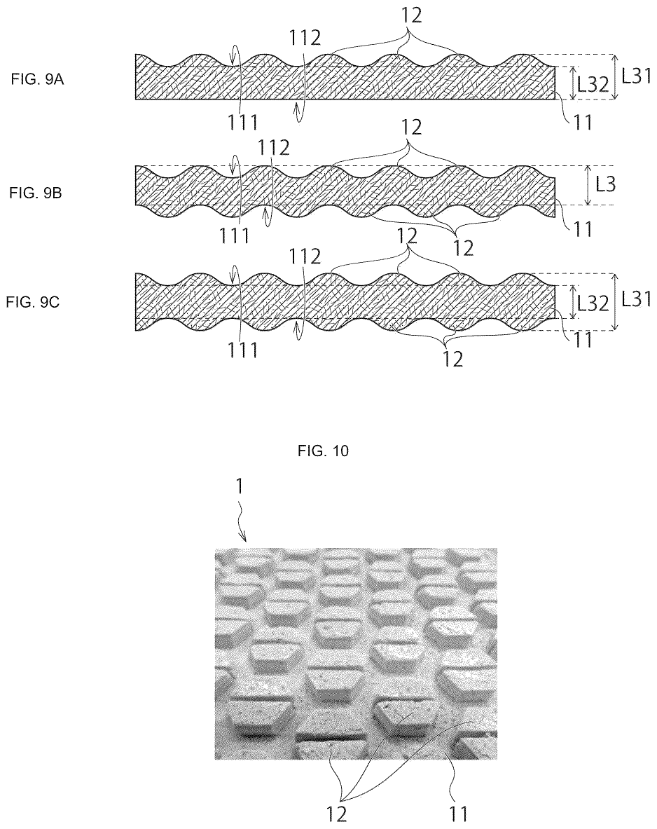

Furthermore, for example, the paper foam material can be molded into a form as an alternative to the bubble cushioning material as illustrated in FIG. 7, a simple sheet shape as illustrated in FIG. 8, a form having wavy protrusions on one or both surfaces as illustrated in A to C of FIG. 9, and the like.

The paper foam material 1 used for the packing material according to the present technology can include a sheet-like base layer 11 having a first surface 111 and a second surface 112. A thickness L1 (see FIG. 7) of the base layer 11 can be freely designed according to the application and purpose of the paper foam material 1. The thickness L1 (see FIG. 7) of the base layer 11 can be, for example, 1 mm or more, preferably 2 mm or more, and 3 mm in consideration of cushioning properties and moldability. By setting the thickness L1 (see FIG. 7) of the base layer 11 within this range, the strength of the paper foam material 1 can be further improved.

A plurality of structural bodies 12 can be formed on the first surface 111 and/or the second surface 112 of the base layer 11. The shape of the structural body 12 is not particularly limited, and can be formed into shapes illustrated in FIGS. 7 and 9, the shape illustrated in FIGS. 10 and 11 described later, and the like. Although not illustrated, a shape can be formed by combining the structural bodies 12 having different shapes or a plurality of structural bodies 12 can be individually formed in different shapes. Moreover, the plurality of structural bodies 12 can be formed at intervals.

The thickness of the structural body 12 can be freely designed according to the application and purpose of the paper foam material 1. A thickness L2 (see FIG. 7) of the structural body 12 can be set to, for example, 2 to 10 mm; for example, in the case of the shape in FIG. 10 described later, the thickness L2 can be preferably set to 8 to 10 mm; and for example, in the case of the shape in FIG. 11 described later, the thickness L2 can be preferably set to 2 to 6 mm. By setting the thickness L2 (see FIG. 7) of the structural body 12 within this range, the strength of the paper foam material 1 can be further improved.

In the paper foam material 1 used for the packing material according to the present technology, the thickness L2 (see FIG. 7) of the structural body 12 is preferably formed to be thicker than the thickness L1 (see FIG. 7) of the base layer 11. By forming the thickness L2 (see FIG. 7) of the structural body to be thicker than the thickness L1 (see FIG. 7) of the base layer 11, impact resistance, restorability after impact, and the like can be further improved.

A thickness L3 (see FIG. 9B) of the paper foam material 1 obtained by adding the thickness L1 (see FIG. 7) of the base layer 11 and the thickness L2 (see FIG. 7) of the structural body 12 may be a constant thickness as shown in B of FIG. 9, or may be a structure having a thick portion L31 and a thin portion L32 as illustrated in A and C of FIG. 9.

In the paper foam material 1 used for the packing material according to the present technology, the surface roughness of one or more surfaces selected from the first surface 111 and the second surface 112 of the base layer 11, and the surface of the structural bodies 12 can also be freely designed according to the application and purpose of the paper foam material 1.

In the molding step S5, a mold and/or an embossed sheet can be used. As the material of the mold and/or the embossed sheet used in the present technology, molds and/or embossed sheets of various materials can be used as long as the effects of the present technology are not impaired. As the material of the mold and/or the embossed sheet that can be used in the present technology, either an organic material or an inorganic material can be used, and examples of the material include a silicone resin, an acrylic resin, metal, a glass material, a ceramic material, and the like. In the present technology, it is preferable to use a mold containing silicon such as a silicone resin and/or an embossed sheet from the viewpoint that the drying step can be performed in a state where the composition is poured into the mold and/or onto the embossed sheet. By using the mold containing silicon and/or the embossed sheet, releasability and transferability are improved, and the surface quality of each surface of the paper foam material 1 after molding can be improved.

### (6) Drying Step S6

The drying step S6 is a step in which the composition 10 after the foaming step S4 is dried after being molded in the molding step S5 as necessary. The drying method in the drying step S6 can be performed by one or a combination of two or more of general drying methods as long as the effects of the present technology are not impaired. Examples of the drying method include natural drying, heat drying, hot air drying, reduced pressure drying, freeze drying, dehumidification drying, microwave drying, light drying (infrared carbon lamp heater drying, infrared ceramic heater drying, or the like), and the like.

Examples of the paper foam material 1 manufactured by performing the above steps are shown in the drawing-substituting photographs in FIGS. 5, 10, and 11. The example shown in FIG. 5 is an example in which an embossed sheet containing silicon is molded and manufactured in the molding step S5. The examples shown in FIGS. 10 and 11 are examples in which a mold containing silicon is molded and manufactured in the molding step S5.

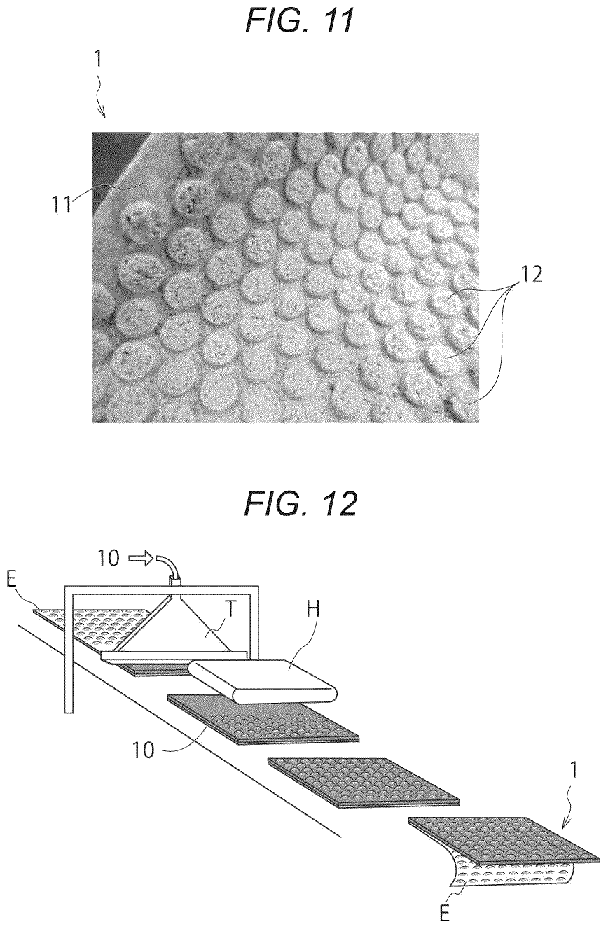

FIG. 12 is a schematic view illustrating an example of the manufacturing method of the paper foam material 1 used in the present technology. The manufacturing method illustrated in FIG. 12 is an example of molding by using a belt conveyor and an embossed sheet. The composition 10 subjected to the mixing step S3 and the foaming step S4 is made to flow onto an embossed sheet E by using an extruder T such as a T-die, and in this state, the composition is dried by using a dryer H such as a heater, and then, the embossed sheet E is peeled off from the paper foam material 1, and as a result, the paper foam material 1 used for the packing material according to the present technology can be manufactured.

Note that, in the example illustrated in FIG. 12, the composition 10 on the embossed sheet E is dried by using the dryer H in a shape following the shape of the embossed sheet E, and the manufactured paper foam material 1 is also molded into a sheet shape subjected to embossing. However, the paper foam material 1 having a form as illustrated in A of FIG. 9 can also be molded by increasing the thickness of the composition 10 poured onto the embossed sheet E. More specifically, by increasing the thickness of the composition 10 poured onto the embossed sheet E, the surface not in contact with the embossed sheet E in FIG. 12 becomes flat and forms the second surface 112 illustrated in A of FIG. 9, and the surface in contact with the embossed sheet E in FIG. 12 forms the first surface 111 illustrated in A of FIG. 9.

The specific thickness varies depending on the fluidity state and the like of the composition 10, but for example, by setting the thickness of the composition 10 poured onto the embossed sheet E to about 2 to 3 mm, the sheet-like paper foam material 1 subjected to embossing shown in FIG. 5 can be molded, and by setting the thickness of the composition 10 poured onto the embossed sheet E to 5 mm or more, the paper foam material 1 having a form as illustrated in A of FIG. 9 can be molded.

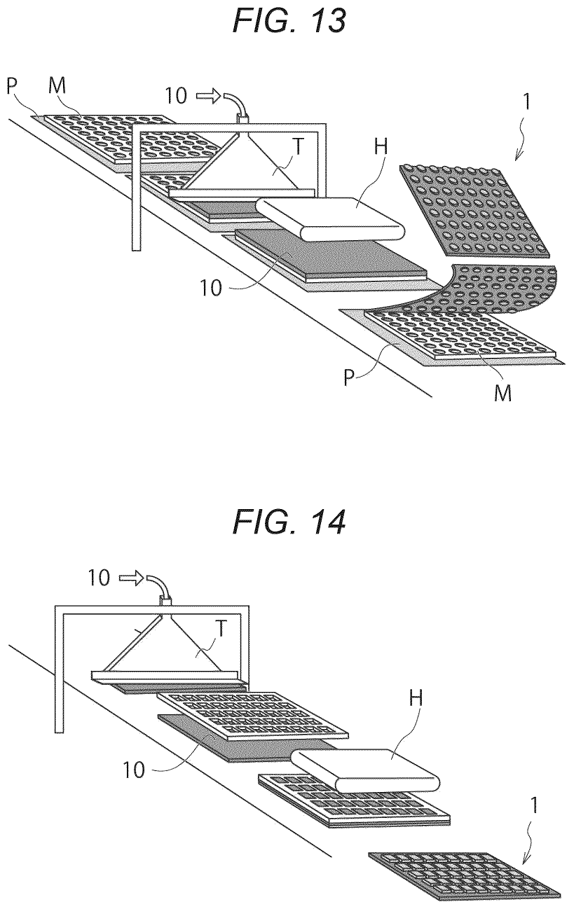

FIG. 13 is a schematic view illustrating an example, different from that in FIG. 12, of the manufacturing method of the paper foam material 1 used in the present technology. The manufacturing method illustrated in FIG. 13 is an example of molding the paper foam material by using a belt conveyor and a mold M. The composition 10 subjected to the mixing step S3 and the foaming step S4 is poured into the mold M by using an extruder T such as a T-die, and in this state, the composition is dried by using a dryer H such as a heater, and then, the paper foam material 1 is peeled off from the mold M, and as a result, the paper foam material 1 used for the packing material according to the present technology can be manufactured.

At this time, from the viewpoint of improving the moldability and improving the designability and surface roughness of the paper foam material 1 after being manufactured, the mold M is preferably provided with holes for releasing air, and for example, a porous sheet P or the like such as a mesh material sheet is laid under the mold M. An example of the porous sheet P is a sheet using a material such as polyvinyl chloride (PVC). By laying the porous sheet P including polyvinyl chloride (PVC) or the like, the permeability of the composition 10 into the mold M is improved, and the molding accuracy can be improved.

Note that, in the example of FIG. 13, the drying step S6 is performed in a state where the composition 10 is poured into the mold M, but the present invention is not limited thereto, and it is also possible to perform rough drying to such an extent that the mold M can be removed in a state where the composition 10 is poured into the mold M, and perform main drying in a state where the composition is removed from the mold M.

Furthermore, in the example of FIG. 13, the manufactured paper foam body 1 is peeled off from the mold M, but the present invention is not limited thereto, and the manufactured paper foam body can be separated from the mold M by peeling off the mold M after the porous sheet P is peeled off.

FIG. 14 is a schematic view illustrating an example, different from those in FIGS. 12 and 13, of the manufacturing method of the paper foam material 1 used in the present technology. The manufacturing method illustrated in FIG. 14 is an example of molding the paper foam material by using a belt conveyor and a mold M. The composition 10 subjected to the mixing step S3 and the foaming step S4 is made to flow onto a belt conveyor by using an extruder T such as a T-die, and the mold M is pressed from above to a desired depth. In this state, the composition is dried by using a dryer H such as a heater, and then, the paper foam material 1 is peeled off from the mold M, and as a result, the paper foam material 1 used for the packing material according to the present technology can be manufactured.

In the manufacturing method illustrated in FIG. 14, by pressing the mold M, the composition 10 at the portion of the hole is pushed out and swelled, and a top part of a portion to be the structural body 12 can be formed to have a rounded shape. With this arrangement, the shape stability of the manufactured paper foam material 1 can be improved.

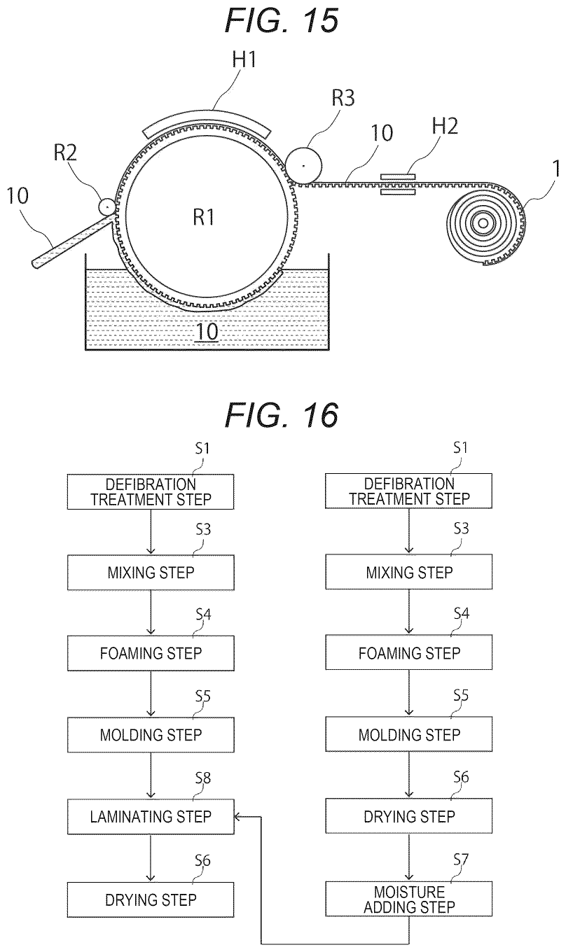

FIG. 15 is a schematic view illustrating an example, different from those in FIGS. 12, 13, and 14, of the manufacturing method of the paper foam material 1 used in the present technology. The manufacturing method illustrated in FIG. 15 is an example of molding the paper foam material by using a roller R. A part of a first roller R1 having dents and protrusions on a surface thereof is immersed in a tank containing the composition 10 subjected to the mixing step S3 and the foaming step S4, and the composition 10 is deposited on the surface of the first roller R1. At this time, the dents and protrusions of the surface of the roller R1 is provided with pores having a size small enough for the composition 10 not to flow therethrough, and by performing suction from inside the roller R1, the composition 10 can be deposited on the surface of the first roller R1.

The composition 10 deposited on the surface of the first roller R1 has the surface thereof adjusted by using a second roller R2 or a belt saw (not illustrated) or the like, is roughly dried by using a first dryer H1 such as a heater, then is taken up by using, for example, a third roller R3 or the like, and is finally dried by using a second dryer H2 such as a heater, and as a result, the paper foam material 1 used for the packing material according to the present technology can be manufactured.

Note that, in the example of FIG. 15, after the rough drying is performed on the first roller R1 by using the first dryer H1, the paper foam material 1 is removed from the first roller R1, and then, the main drying is performed by using the second dryer H2. However, the present invention is not limited thereto, and the paper foam material 1 may be removed from the first roller R1 after the drying is completed on the first roller R1 by using the first dryer H1. Furthermore, by providing the first roller R1 with a heating mechanism, the drying can be performed only by the heat of the first roller R1 without using the dryer H1.

### Third Embodiment

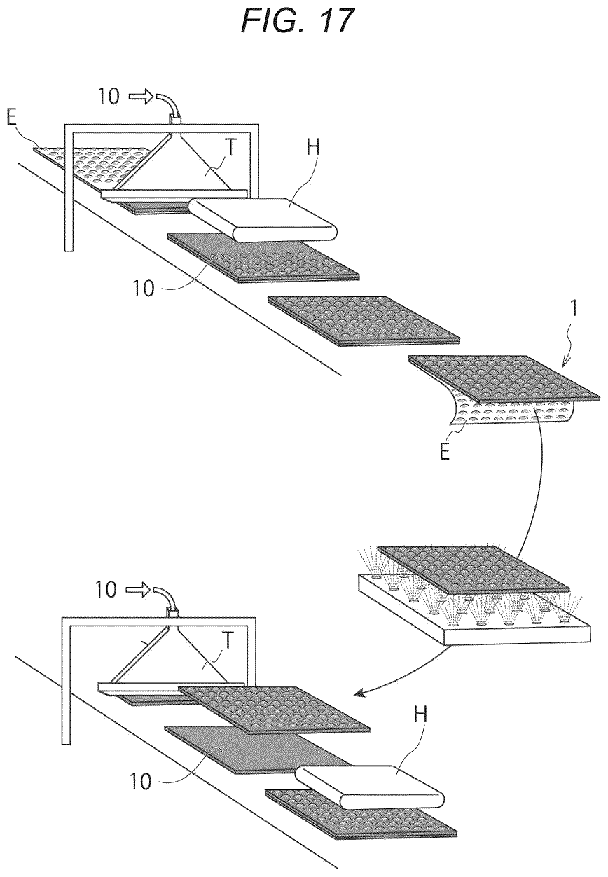

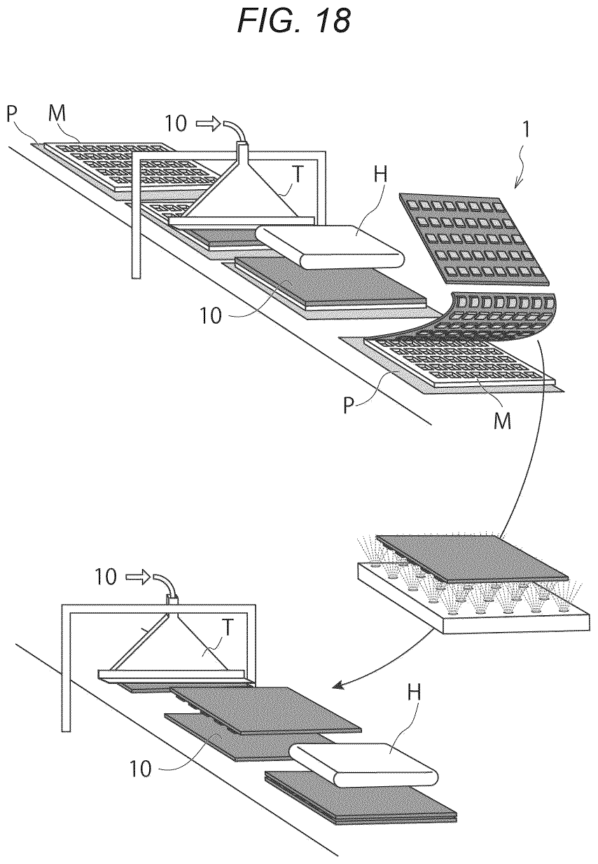

FIG. 16 is a flowchart of a third embodiment of a manufacturing method of the paper foam material 1 used in the present technology. FIGS. 17 and 18 are schematic views illustrating the third embodiment of the manufacturing method of the paper foam material 1 used in the present technology. The manufacturing method of the paper foam material 1 according to the third embodiment is a method in which a moisture adding step S7 and a laminating step S8 are performed in addition to each of the steps performed by the manufacturing method according to the first embodiment or the second embodiment.

### (7) Moisture Adding Step S7

The moisture adding step S7 is a step of moistening the composition after drying with a liquid before the laminating step S8 described later. By performing the moisture adding step S7, the adhesiveness of the composition after drying and the composition after foaming in the laminating step S8 described later can be improved, and the moldability can also be improved.

Note that, in the manufacturing method according to the present technology, the moisture adding step S7 is not an essential step, and the moisture adding step S7 can be omitted by, for example, in the laminating step S8, applying an adhesive to a laminating surface of the composition after drying and/or the composition after foaming, or roughly drying the composition to be laminated and laminating the composition, which is not completely dried, on the composition after foaming.

Examples of the liquid used in the moisture adding step S7 include water, solutions containing various types of chemicals such as an adhesive, and the like, and among these liquids, water is preferably used from the viewpoint of cost and work efficiency.

As a specific method in the moisture adding step S7, a freely-selected method can be used as long as the functions and effects according to the present technology are not impaired. Examples of the method include a method in which a liquid is sprayed onto the laminating surface of the composition after drying, a method in which the laminating surface of the composition after drying is immersed in a liquid, and the like.

### (8) Laminating Step S8 (First Laminating Step)

The laminating step S8 (also referred to as a “first laminating step”) is a step of laminating the composition after drying on the composition after foaming. That is, as illustrated in the flowchart of FIG. 16, the first laminating step is a step of laminating the paper foam body 1 (the composition after drying) manufactured by the manufacturing method according to the first embodiment on the composition after the foaming step in another manufacturing line.

By performing the laminating step S8, the performance such as impact resistance, sound absorbing properties, sound insulating properties, vibration-proof properties, heat insulating properties, and flame-proofing properties of the manufactured paper foam body 1 can be improved.

As the thickness of the composition 10 becomes thicker, the drying time in the drying step S6 described above becomes longer. Therefore, as in the manufacturing method according to the third embodiment, the paper foam material 1 having a large thickness can be efficiently manufactured by laminating the already manufactured paper foam material 1 (the composition after drying) on the composition after the foaming step in another manufacturing line.

### Fourth Embodiment

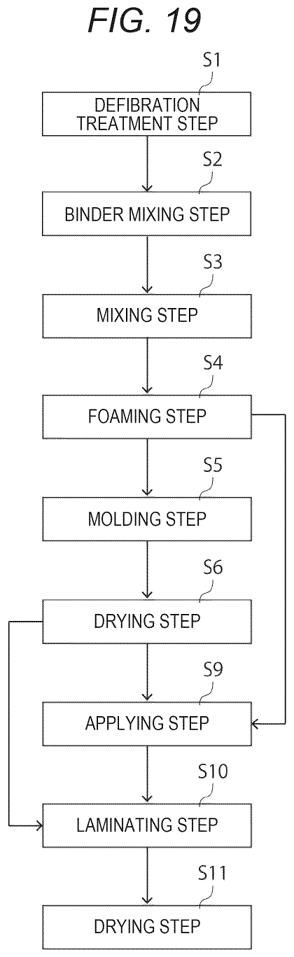

FIG. 19 is a flowchart of a fourth embodiment of a manufacturing method of the paper foam material 1 used in the present technology. The manufacturing method of the paper foam material 1 according to the fourth embodiment is a method in which an applying step S9, a laminating step S10, and a drying step S11 are performed in addition to each of the steps performed by the manufacturing method according to the first embodiment or the second embodiment. Note that, in the flowchart of FIG. 19, the method of further performing the applying step S9, laminating step S10, and the drying step S11 is exemplified in the manufacturing method according to the second embodiment.

### (9) Applying Step S9

The applying step S9 is a step of applying the composition 10 after the foaming step S4 to the surface of the paper foam material 1 manufactured by the manufacturing method according to the first embodiment. The applying method in the applying step S9 can be performed by one or a combination of two or more of general application methods as long as the effects of the present technology are not impaired. Examples of the applying method include roll applying, kiss applying, spray applying, brush applying, transfer by stamping, and the like.

### (10) Laminating Step S10 (Second Laminating Step)

The laminating step S10 (also referred to as a “second laminating step”) is a step of laminating the paper foam material 1 manufactured by the manufacturing method according to the first embodiment on the surface to which the composition 10 is applied in the applying step S9. That is, in the second laminating step S10, the paper foam material 1, the composition 10 before drying, and the paper foam material 1 are laminated in this order. At this time, the composition 10 before drying sandwiched between the paper foam materials 1 functions as an adhesive for bonding the paper foam materials 1 to each other.

### (11) Drying Step S11

The drying step S11 is a step of drying the laminate after the second laminating step S10. In the drying step S11, in the actual case, because the paper foam material 1 is in an already dried state, drying of the composition 10 sandwiched between the paper foam materials 1 is performed. Because the drying method in the drying step S11 is similar to that in the drying step S6 described above, the description thereof is omitted here.

As the thickness of the composition 10 becomes thicker, the drying time in the drying step S6 described above becomes longer. Therefore, as in the manufacturing method according to the second embodiment, the paper foam material 1 having a large thickness can be efficiently manufactured by performing the drying step S11 in a state where the already manufactured paper foam materials 1 are bonded together by using the composition 10 before drying.

### 3. Composite Material 2

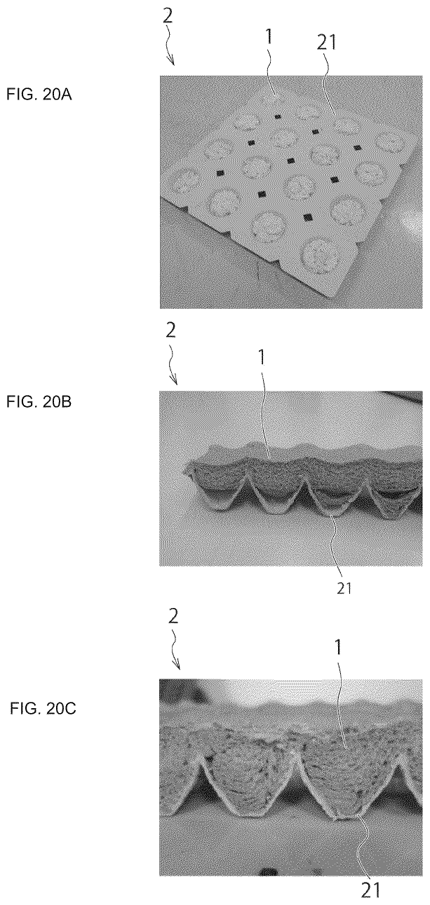

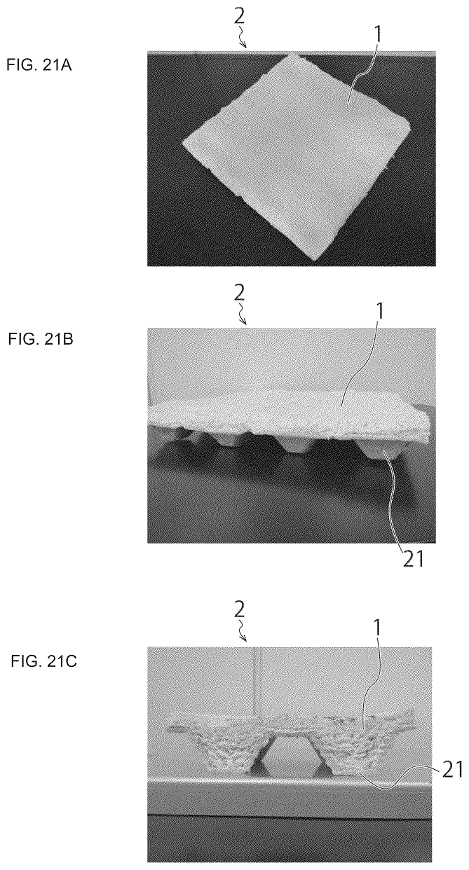

FIGS. 20 and 21 are drawing-substituting photographs illustrating examples of a composite material 2 that can be used as the packing material according to the present technology. The composite material 2 according to the present technology includes the paper foam material 1 used in the present technology described above and a base material 21.

### (1) Base Material 21

The base material 21 of the composite material 2 according to the present technology is not particularly limited as long as the effects of the present technology are not impaired, and the base material 21 using any material can be used. As the material of the base material 21 that can be used in the present technology, waste paper such as newspaper, magazine, book, and corrugated cardboard, pulp such as bamboo, bagasse, and straw, woven fabrics such as cotton fabrics, wool fabrics, and chemical fiber fabrics, a resin, and the like can be used. In the present technology, it is preferable to use the base material 21 containing waste paper and/or pulp. By using the fibrous material containing waste paper and/or pulp, recyclability can be improved. The waste paper can include, for example, newspaper, magazines, books, corrugated cardboard, and the like as described above. The pulp can include wood, non-wood, and the like. Examples of the non-wood can include bamboo, bagasse, straw, and the like.

In the examples of FIGS. 20 and 21, a pulp mold is used as the base material 21. The pulp mold is a recyclable base material 21 including waste paper such as corrugated cardboard, but has problems of having no restorability and low cushioning properties. However, by combining the pulp mold with the paper foam material 1 used in the present technology, the composite material 2 to which restorability is imparted can be obtained, and the cushioning properties can also be improved.

The method of bonding the paper foam material 1 with the base material 21 is not particularly limited as long as the effects of the present technology are not impaired. For example, bonding can be performed with an adhesive layer interposed therebetween, or bonding can be performed by bonding the composition 10 before drying to the base material 21 and then drying the composition. Note that, because the adhesive layer is the same as an adhesive layer 32 of a multilayer structure 3 described later, the description thereof is omitted here.

### (2) Application of Composite Material 2

The application of the composite material 2 used in the present technology described above is not particularly limited, and the composite material 2 can be suitably used for, for example, cushioning materials, packing materials, sound absorbing materials, sound insulating materials, sound-proof materials, vibration-proof materials, heat insulating materials, flame-proof materials, wallpaper, aromatic materials, deodorant materials, seat sheets for automobiles and the like, curing materials, agricultural materials, and the like.

Furthermore, if a recyclable material is used as the base material 21, the application as a recycled material can also be expected. Note that the specific example of the composite material 2 according to the present technology is the same as the specific example of the use of the paper foam material 1 described above, and thus, the description thereof is omitted here.

### 4. Manufacturing Method of Composite Material 2

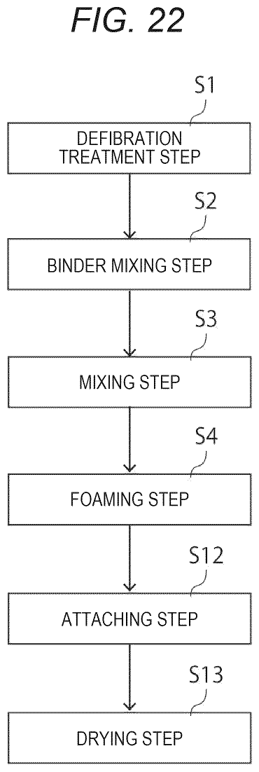

FIG. 22 is a flowchart of a first embodiment of a manufacturing method of the composite material 2 used in the present technology. The manufacturing method of the composite material 2 according to the present technology is a method of performing at least a foaming step S4, an attaching step S12, and a drying step S13. Furthermore, as necessary, a defibration treatment step S1, a binder mixing step S2, a mixing step S3, and the like can also be performed. Hereinafter, details of each step will be described. Note that, because the defibration treatment step S1, the binder mixing step S2, the mixing step S3, and the foaming step S4 are the same as the defibration treatment step S1, the binder mixing step S2, the mixing step S3, and the foaming step S4 of the manufacturing method of the paper foam material 1 used in the present technology described above, the description thereof is omitted here.

### (1) Attaching Step S12

The attaching step S12 is a step of attaching a composition 10 after the foaming step S4 to a base material 21 before the drying step S13 described later. In the attaching step S12, a specific method is not particularly limited as long as the composition 10 before drying can be brought into contact with another base material 21. Examples of the method include a method of attaching by laminating the composition 10 before drying on the base material 21, a method of attaching by applying the composition 10 before drying to the base material 21, a method of attaching by filling the composition 10 before drying in a predetermined portion of the base material 21, and the like.

### (2) Drying Step S13

The drying step S13 is a step of drying the composition 10 after the attaching step S12. By drying the composition 10 before drying in a state of being attached to another base material 21, the paper foam material 1 is formed in a state of being bonded to the base material 21. That is, the composite material 2 including the paper foam material 1 and the base material 21 can be manufactured. Because the drying method in the drying step S13 is similar to that in the drying step S6 described above, the description thereof is omitted here.

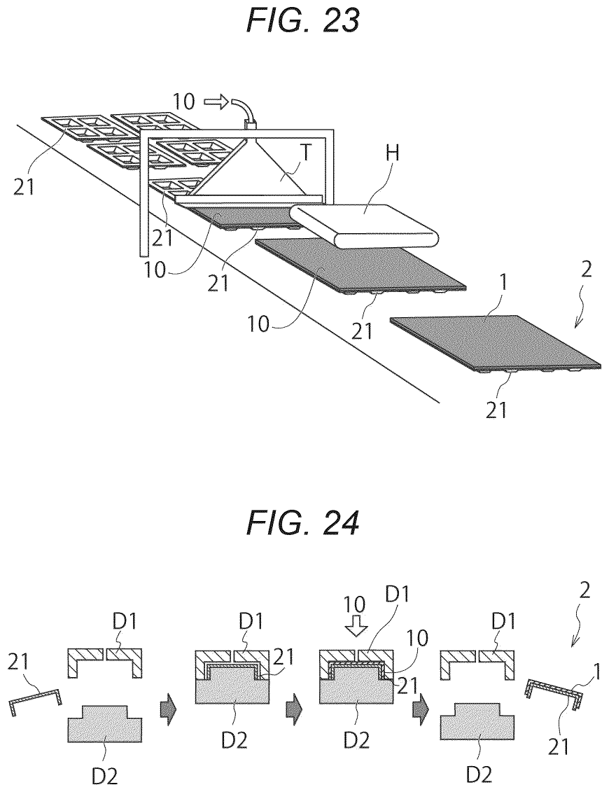

FIG. 23 is a schematic view illustrating an example of the manufacturing method of the composite material 2 according to the present technology. The manufacturing method illustrated in FIG. 23 is an example of molding the composite material by using a belt conveyor. The composition 10 subjected to the mixing step S3 and the foaming step S4 is poured into the base material 21 by using an extruder T such as a T-die, and in this state, the composition is dried by using a dryer H such as a heater, and as a result, the composite material 2 according to the present technology can be manufactured.

At this time, for example, if the base material 21 including a material having air permeability such as pulp mold is used as the base material 21, air can be released from the base material 21 at the time when the composition 10 is poured into the base material 21, and thus, the moldability can be improved and the designability and surface roughness of the produced paper foam material 1 can be improved.

FIG. 24 is a schematic view illustrating an example, different from that in FIG. 23, of the manufacturing method of the composite material 2 according the present technology. The manufacturing method illustrated in FIG. 24 is an example of performing injection molding by using a mold. For example, in a state where the base material 21 is set in a mold D1 on the fixed side by using a mold on the movable side, by injecting and drying the composition 10 subjected to the mixing step S3 and the foaming step S4, the composite material 2 according to the present technology can be manufactured.

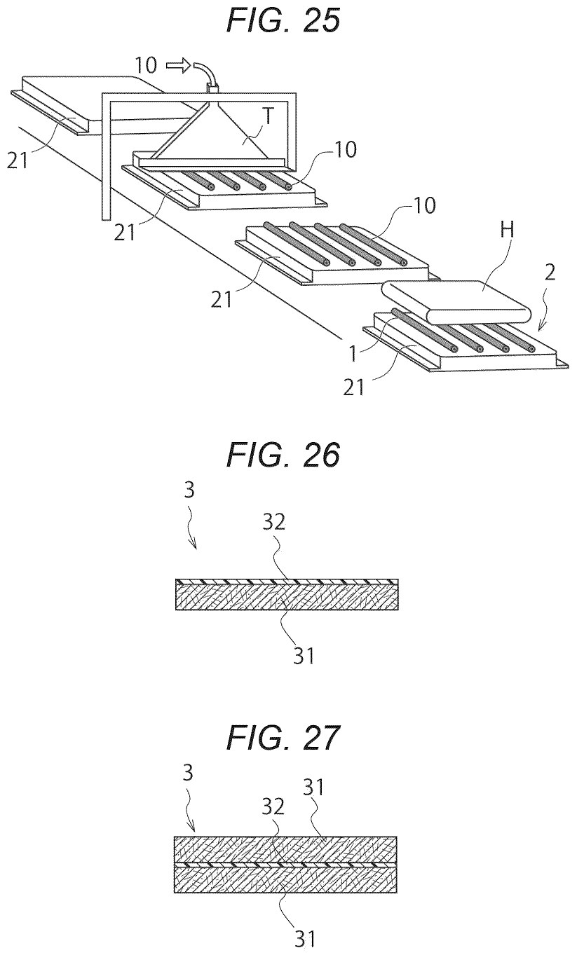

FIG. 25 is a schematic view illustrating an example, different from those in FIGS. 23 and 24, of the manufacturing method of the composite material 2 according the present technology. The manufacturing method illustrated in FIG. 25 is a manufacturing method of the composite material 2 according to the present technology by injecting the composition 10 subjected to the mixing step S3 and the foaming step S4 onto the base material 21 in a desired form and drying the composition.

In the example illustrated in FIG. 25, the composition 10 is injected onto the base material 21 in a rod shape, but the present invention is not limited to this form, and the composition can be designed in a free form on the basis of applications, functions required for the composite material 2, and the like, and designability can be imparted.

### 5. Multilayer Structure 3

FIG. 26 is a schematic view illustrating a first embodiment of the multilayer structure 3 that can be used for the packing material according to the present technology. The multilayer structure 3 according to the present technology includes a paper foam material layer 31 including the paper foam material 1 used in the present technology described above, and the adhesive layer 32.

### (1) Adhesive Layer 32

The material that forms the adhesive layer 32 is not particularly limited as long as the paper foam materials 1 can be adhered to each other or the paper foam material 1 can be adhered to another base material 21, and materials having various adhesive actions can be used. For example, an adhesive including a resin can be used. Examples of the resin forming the adhesive include a urethane resin, a polyolefin resin, an acrylic resin, an epoxy resin, and the like, and these resins can be used alone or in combination of two or more thereof. Furthermore, as in the manufacturing method of the paper foam material 1 according to the second embodiment described above, the foam mixture before drying can be used as the adhesive layer.

### (2) Form of Multilayer Structure 3

The multilayer structure 3 used in the present technology only needs to include at least one or more of the paper foam material layers 31 and one or more of the adhesive layers 32, and the number of each layer is not particularly limited. As in the multilayer structure 3 according to the first embodiment illustrated in FIG. 26, the multilayer structure may have a structure including one paper foam material layer 31 and one adhesive layer 32, and for example, the paper foam material layer 31 and not-illustrated another base material 21 may be adhered with the adhesive layer 32 interposed therebetween.

Furthermore, for example, as in a multilayer structure 3 according to a second embodiment illustrated in FIG. 27, a structure in which the paper foam material layers 31 are adhered to each other with an adhesive layer 32 interposed therebetween can be adopted.

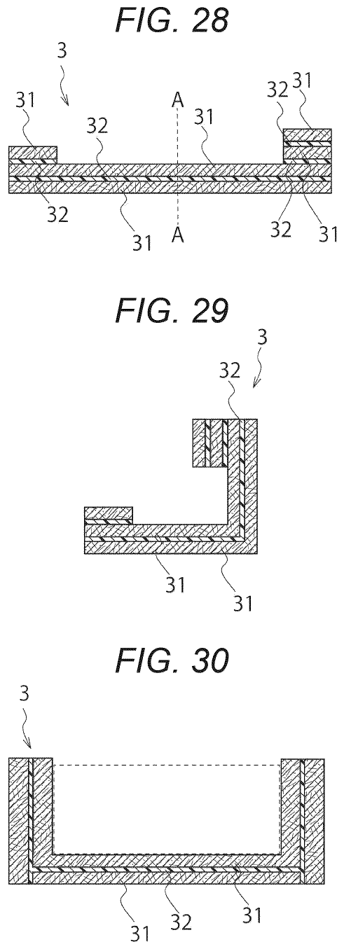

Furthermore, the paper foam material layer 31 and the adhesive layer 32 may have two or more layers, and for example, as in a multilayer structure 3 according to a third embodiment illustrated in FIG. 28, a structure in which different numbers of layers are freely combined according to the application of the multilayer structure 3 and the like can be adopted.

Moreover, for example, the multilayer structure 3 according to the third embodiment illustrated in FIG. 28 may be bent along a line A-A in FIG. 28 to have a form as in a multilayer structure 3 according to a fourth embodiment illustrated in FIG. 29.

In addition, as in a multilayer structure 3 according to a fifth embodiment illustrated in FIG. 30, for example, in a case where the multilayer structure 3 is used as a packing material, a laminated structure may be formed in accordance with the shape of a product to be packed (indicated by a broken line in the drawing).

### (3) Application of Multilayer Structure 3

The application of the multilayer structure 3 used in the present technology described above is not particularly limited, and the multilayer structure 3 can be suitably used for, for example, cushioning materials, packing materials, sound absorbing materials, sound insulating materials, sound-proof materials, vibration-proof materials, heat insulating materials, flame-proof materials, wallpaper, aromatic materials, deodorant materials, seat sheets for automobiles and the like, curing materials, agricultural materials, and the like.

Furthermore, if a recyclable material is used as the adhesive layer 32 described above, the application as a recycled material can also be expected.

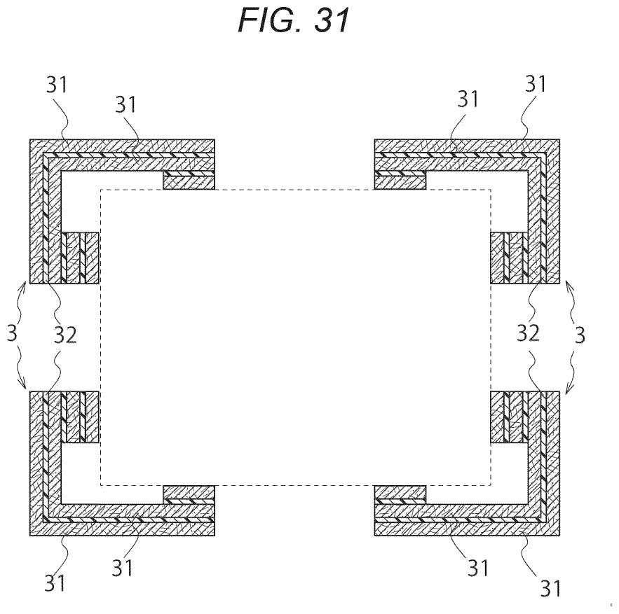

The multilayer structure 3 used in the present technology can be used for various types of applications in a state of being combined with a plurality of multilayer structures. As in a multilayer structure 3 according to a sixth embodiment illustrated in FIG. 31, for example, in a case where the multilayer structure 3 is used as a packing material, the plurality of multilayer structures 3 may be used to pack a product to be packed (indicated by a broken line in the drawing).

### 6. Manufacturing Method of Multilayer Structure 3

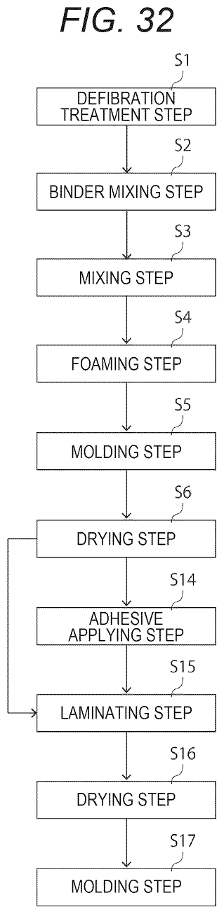

FIG. 32 is a flowchart of a first embodiment of a manufacturing method of the multilayer structure 3 used in the present technology. The manufacturing method of the multilayer structure 3 according to the present technology is a method of performing at least a foaming step S4, a drying step S6, and a laminating step S15. Furthermore, if necessary, a defibration treatment step S1, a binder mixing step S2, a mixing step S3, a molding step S5, an adhesive applying step S14, a drying step S16, a molding step S17, and the like can also be performed. Hereinafter, details of each step will be described. Note that, because the defibration treatment step S1, the binder mixing step S2, the mixing step S3, the foaming step S4, and the molding step S5 are the same as the defibration treatment step S1, the binder mixing step S2, the mixing step S3, the foaming step S4, and the molding step S5 of the manufacturing method of the paper foam material 1 used in the present technology described above, the description thereof is omitted here.

### (1) Adhesive Applying Step S14

The adhesive applying step S14 is a step of applying an adhesive to the surface of the paper foam material 1 manufactured through the drying step S6. Because the applying method in the adhesive applying step S12 is similar to that in the applying step S9 described above, the description thereof is omitted here.

### (2) Laminating Step S15 (Third Laminating Step)

The laminating step S15 (hereinafter, also referred to as a “third laminating step”) is a step of laminating the paper foam materials 1 after the drying step with each other with an adhesive layer interposed therebetween. That is, in the third laminating step S15, the paper foam material 1, the adhesive, and the paper foam material 1 are laminated in this order.

### (3) Drying Step S16

The drying step S16 is a step of drying the adhesive to form the adhesive layer 32 after the third laminating step S15. Because the drying method in the drying step S16 is similar to that in the drying step S6 described above, the description thereof is omitted here.

### (4) Molding Step S17

The molding step S17 is a step of molding the manufactured multilayer structure 3 into a desired shape. For example, as described above, the multilayer structure 3 according to the third embodiment illustrated in FIG. 28 may be bent along the line A-A in FIG. 28 to have a form as in the multilayer structure 3 according to the fourth embodiment illustrated in FIG. 29. The molding method performed in the molding step S17 is not limited to the method of performing the molding by bending, and can include molding by cutting, molding by adhesion, molding by lamination, molding by combining the above methods, and the like.

Note that the present technology can also have the following configurations.
(1)

A paper foam material including:
a fibrous material containing waste paper and/or pulp;
a binder;
sodium hydrogen carbonate; and
a surfactant, and including:
a water-soluble softener; and
carboxylic anhydride having a saturated hydrocarbon group and/or an unsaturated hydrocarbon group.
   (2)

The paper foam material according to (1), in which the carboxylic anhydride has a molar ratio of 0.01 to 2 with respect to the softener.

(3)

The paper foam material according to (1) or (2), in which the saturated hydrocarbon group and/or the unsaturated hydrocarbon group has a number of carbon atoms of 12 to 24.

(4)

The paper foam material according to any one of (1) to (3), in which the carboxylic anhydride includes alkenyl carboxylic anhydride.

(5)

The paper foam material according to (4), in which the alkenyl carboxylic anhydride includes octadecenyl carboxylic anhydride.

(6)

The paper foam material according to (5), in which the octadecenyl carboxylic anhydride includes octadecenyl succinic anhydride.

(7)

The paper foam material according to any one of (1) to (6), in which the softener includes polyhydric alcohol.

(8)

The paper foam material according to any one of (1) to (7), further including an anti-tarnishing agent.

(9)

The paper foam material according to (8), in which the anti-tarnishing agent contains alum.

(10)

The paper foam material according to any one of (1) to (9), further including an antibacterial agent.

(11)

The paper foam material according to (10), in which the antibacterial agent contains potassium sorbate.

(12)

The paper foam material according to any one of (1) to (11), in which the binder contains polyvinyl alcohol.

(13)

The paper foam material according to any one of (1) to (12), in which the surfactant contains polyoxyethylene alkyl ether.

(14)

The paper foam material according to any one of (1) to (13), in which the paper foam material has a sheet shape subjected to one or more processing selected from embossing, indenting processing, protruding processing, and hollow processing.

(15)

The paper foam material according to any one of (1) to (14), in which the paper foam material is bonded to a base material with an adhesive layer interposed between the paper foam material and the base material.

(16)

The paper foam material according to any one of (1) to (15), in which the paper foam material is used for one or more applications selected from cushioning material use, packing material use, sound absorbing material use, heat insulating material use, and flame-proof material use.

(17)

A manufacturing method of a paper foam material, the manufacturing method including:
a mixing step of mixing a composition including
a fibrous material containing waste paper and/or pulp,
a binder,
sodium hydrogen carbonate, and
a surfactant, and including
a water-soluble softener, and
carboxylic anhydride having a saturated hydrocarbon group and/or an unsaturated hydrocarbon group; and
a foaming step of foaming the composition.
   (18)

The manufacturing method of the paper foam material according to (17), further including a molding step of molding the composition by using a mold and/or an embossed sheet.

(19)

The manufacturing method of the paper foam material according to (17) or (18), further including a drying step of drying the composition after foaming.

(20)

The manufacturing method of the paper foam material according to (18), further including a laminating step of laminating the composition after drying on the composition after foaming.

(21)

The manufacturing method of the paper foam material according to (20), further including, before the laminating step, a moisture adding step of moistening the composition after drying with a liquid.

### EXAMPLES

Hereinafter, the present technology will be described in more detail on the basis of examples. Note that the examples to be described below describe an example of a representative embodiment of the present invention, and the scope of the present technology is not narrowed by the example.

### Experimental Example 1

In Experimental example 1, the influence on various types of physical properties due to the difference in materials used for the paper foam material was examined. Note that, in the present experimental example, as an example of alkenyl carboxylic anhydride, octadecenyl carboxylic anhydride is used.

### (1) Manufacturing of Paper Foam Material

The materials shown in the following Tables 1 and 2 were weighed and mixed, and then the composition 10 was prepared while being stirred and mixed by using a foaming instrument. The composition 10 was extended into a plate shape and naturally dried under conditions of a temperature of 23° C. and a humidity of 50% for 20 hours to manufacture the paper foam materials of Control and Samples 1 to 8.

TABLE 1

| | | |
|---|---|---|
| Fibrous material | Type | Waste corrugated cardboard |
| | | (Pre-crushed) |
| | Added | 100 |
| | amount | |
| | (g) | |
| Binder | Type | Polyvinyl alcohol (PVA) |
| | Added | 34 (Water: 425) |
| | amount | |
| | (g) | |
| Surfactant | Type | Polyoxyethylene alkyl ether |
| | | (“HITENOL” (Registered Trademark) |
| | | Manufactured by DKS Co. LTD. ) |
| | Added | 0.9 (Water:100) |
| | amount | |
| | (g) | |
| Anti-tarnishing | Type | Alum |
| agent | Added | 1.75 (Water: 35) |
| | amount | |
| | (g) | |
| Anti-fungal | Type | Potassium sorbate |
| agent/Antibacterial | Added | 0.34 |
| agent | amount | |
| | (g) | |
| Foam accelerator | Type | Sodium bicarbonate |
| | Added | 5 |
| | amount | |
| | (g) | |
| Softener | Type | See Table 2 |
| | Added | |
| | amount | |
| | (g) | |
| Carboxylic | Type | See Table 2 |
| anhydride | Added | |
| | amount | |
| | (g) | |

### (2) Evaluation

Impact resistance, restorability after impact, flexibility (moisture retaining properties), and migration properties of each foam material were evaluated according to the following evaluation criteria.

### [Impact Resistance]

A test piece having a length of 150±5 mm, a width of 150±5 mm, and a thickness of 50±5 mm was prepared by using each foam material produced on the basis of JIS standard Z0235, and the test piece was left for 16 hours or more under conditions of a temperature of 23±2° C. and a humidity of 50±5%, and then, the state of the foam material at the time when a weight was dropped by free fall from 60 cm was observed.
◯: The foam material was not broken
x: The foam material was broken
   [Restorability after Impact]

After the impact resistance test, the state of the foam material after removing the iron ball was observed.
◯: The foam material was immediately restored to its original shape
x: The foam material was not restored to its original shape even after a while

### [Flexibility (Moisture Retaining Properties)]

The cushioning properties of the manufactured foam material was evaluated according to the following criteria.
◯: Cushioning properties were maintained
x: Cushioning properties were lost

### [Migration Properties]

The manufactured foam material was stored in contact with a stainless steel plate at a high temperature of 90 to 95% and a high humidity of 65±2° C. for 24 hours, and then, the occurrence of “migration of the foam material” to the plate was observed.
1: Complete migration occurred
2: Migration occurred
3: Migration occurred, but could be wiped off
4: Slight migration occurred
5: No migration was observed

### (3) Result

The results are shown in Table 2.

TABLE 2

| | | Control | Sample | | | | | | | |
|---|---|---|---|---|---|---|---|---|---|---|
| | | 1 | 1 | 2 | 3 | 4 | 5 | 6 | 7 | 8 |
| Softener | Type | None | Glycerin | Ethylene | Urea | Urea | Propylene | 1,3- | Trehalose | Glycerin |
| | | | | glycol | | | glycol | Butylene | | |
| | | | | | | | | glycol | | |
| | Added | 0 | 45 | 45 | 0.1 | 20 | 45 | 45 | 5 | 22.5 |
| | amount (g) | | | | (Water: | (Water: | | | (Water: | |
| | | | | | 44.9) | 25) | | | 40 | |
| Carboxylic | | — | — | — | — | — | — | — | — | 15.75 |
| anhydride added | | | | | | | | | | (Water: |
| amount (g) | | | | | | | | | | 87.2) |
| Evaluation | Impact | ◯ | ◯ | ◯ | ◯ | ◯ | ◯ | ◯ | ◯ | ◯ |
| | resistance | | | | | | | | | |
| | Restorability | ◯ | ◯ | ◯ | ◯ | ◯ | ◯ | ◯ | ◯ | ◯ |
| | after | | | | | | | | | |
| | impact | | | | | | | | | |
| | Moisture | ◯ | ◯ | ◯ | ◯ | ◯ | ◯ | ◯ | ◯ | ◯ |
| | retaining | | | | | | | | | |
| | properties | | | | | | | | | |
| | Migration | 5 | 1 | 3 | 5 | 4 | 4 | 4 | 4 | 5 |
| | properties | | | | | | | | | |

As shown in Table 2, in Control in which the softener was not added, the evaluation of the migration properties was good, but the evaluation of the moisture retaining properties was poor, and the foamability was poor. On the other hand, as shown in Samples 1 to 8, it has been found that by blending the softener, good foaming and dry states are obtained, and moreover, the moisture retaining properties are improved, and the elastic effect and cushioning properties of the foam material are improved.

Furthermore, as shown in Samples 1 to 7, it has been found that the degree of “migration” from the foam material to the object in contact varies depending on the type of softener. Specifically, as compared with Samples 1 and 2 using glycerin or ethylene glycol, Samples 3 to 6 has a higher evaluation of transferability, that is, it has been shown that the occurrence of “migration” can be further suppressed, where Samples 3 to 6 uses urea which is a urea derivative having a chemical structural formula of R¹, R²—N—CO—N—R³, R⁴ (R¹ to R⁴: H or a saturated and/or unsaturated hydrocarbon group with C of 1 to 4), or propylene glycol or butylene glycol which is a polyhydric alcohol having 3 to 15 water-soluble carbon atoms and in which the relationship between the number of carbon atoms and the number of hydroxy (OH) groups in the molecular structure of the polyhydric alcohol is the number of hydroxyl groups<the number of carbon atoms.

Moreover, as shown in the results of Sample 1 and Sample 8, it has been shown that even in a case where glycerin having a high occurrence of “migration” is used, the occurrence of “migration” can be suppressed by using carboxylic anhydride in combination.

### Experimental Example 2

In Experimental example 2, the influence on various types of physical properties due to the difference in fibrous materials was examined.

### (1) Manufacturing of Paper Foam Material

By using the materials shown in Tables 3 and 4 below, the paper foam materials were manufactured in the similar manner as in Experimental example 1.

TABLE 3

| | | |
|---|---|---|
| Fibrous material | Type | See Table 4 |
| | Added | 500 |
| | amount | |
| | (g) | |
| Binder | Type | Polyvinyl alcohol (PVA) |
| | Added | 170 (Water: 2125) |
| | amount | |
| | (g) | |
| Surfactant | Type | Polyoxyethylene alkyl ether |
| | | (“HITENOL” (REGISTERED |
| | | TRADEMARK) Manufactured by |
| | | DKS Co. LTD.) |
| | Added | 4.5 (Water: 500) |
| | amount | |
| | (g) | |
| Anti-tarnishing | Type | Alum |
| agent | Added | 8.75 (Water: 175) |
| | amount | |
| | (g) | |
| Anti-fungal | Type | Potassium sorbate |
| agent/Antibacterial | Added | 1.7 |
| agent | amount | |
| | (g) | |
| Foam accelerator | Type | Sodium bicarbonate |
| | Added | 25 |
| | amount | |
| | (g) | |
| Softener | Type | Glycerin |
| | Added | 112.5 |
| | amount | |
| | (g) | |
| Carboxylic | Type | Octadecenyl carboxylic anhydride |
| anhydride | Added | 78.75 (Water: 436) |
| | amount | |
| | (g) | |

### (2) Evaluation

### [Tensile Strength]

The tensile strength of each of the manufactured paper foam materials was measured in accordance with JIS Z1702.

### [Manufacturability]

For each of the manufactured paper foam materials, the manufacturability of each of the paper foam materials was evaluated according to the following evaluation criteria.
⊚: Very good (Stable foaming and discharge are observed from the beginning to the end of slurry discharge. A turbomix head is continuously rotated without any trouble.)
◯: Good (Stable foaming and discharge are observed at the beginning of slurry discharge, but due to specific gravity, feeding failure occurs as a remaining amount in a hopper decreases. The problem is solved by performing a method of adding weight and hot water. A turbomix head is continuously rotated without any trouble.)
x: Poor (Stable foaming and discharge are observed at the beginning of slurry discharge, but the amount of discharge gradually decreases, and eventually, a turbomix head gets clogged.)

### [Processability]

For each of the manufactured paper foam materials, the processability of each of the paper foam materials was evaluated according to the following evaluation criteria.
⊚: Very good (Slurry applied from a T-die to a mold plate can be uniformly foamed and stably molded. Consolidation settlement after drying is within about a half of the applied amount regardless of a pulverize mesh diameter, and the cushioning properties are maintained.)
◯: Good (Slurry applied from a T-die to a mold plate can be uniformly foamed and stably molded, but the amount of consolidation settlement changes depending on a pulverize mesh diameter. As a result, there is a difference in thickness and cushioning properties.)
x: Poor (Because slurry is not discharged and a turbomix head gets clogged, molding cannot be performed.)

### (3) Result

The results are shown in Table 4.

TABLE 4

| | | | | | Product strength | | |
|---|---|---|---|---|---|---|---|
| | | | | | (Tensile strength) | | |
| | | | | | Mpa = N/mm² | | |
| | | | | | Upper | Upper | |
| | | | | | part: | part: | |
| | | | | | Tensile | Tensile | |
| | | | | | strength | strength | |
| | | | | | (N/cm) | (MPa) | |
| | | | | | Lower | Lower | |
| | Length | | | | part: | part: | |
| | of | | | | Elongation | Elongation | |
| Material | fiber | Manufacturability | Processability | | (%) | (%) | Determination |
| Waste | 0.8 | ⊙ | ⊙ | Longitudinal | 15.92 | 0.52 | ◯ |
| corrugated | mm to | | | | 6.53 | 6.53 | |
| cardboard | 1 mm | | | Transverse | 22.59 | 0.74 | ◯ |
| | | | | | 6.5 | 6.5 | |
| Bamboo | 0.5 | ◯ | ⊙ | Longitudinal | 13.12 | 0.17 | ◯ |
| | mm to | | | | 12.18 | 12.18 | |
| | 0.8 | | | Transverse | 23.95 | 0.31 | ◯ |
| | mm | | | | 10.32 | 10.32 | |
| Mixed | 0.5 | ◯ | ◯ | Longitudinal | 18.14 | 0.7 | ◯ |
| material | mm to | | | | 10.88 | 10.88 | |
| of | mm | | | Transverse | 39.09 | 1.46 | ◯ |
| bamboo, | | | | | 11.18 | 11.18 | |
| bagasse, | | | | | | | |
| and | | | | | | | |
| publicly- | | | | | | | |
| collected | | | | | | | |
| waste | | | | | | | |
| paper | | | | | | | |
| Waste | 0.8 | ◯ | ⊙ | Longitudinal | 12.47 | 0.19 | Δ |
| newspaper | mm to | | | | 5.42 | 5.42 | |
| | 1 mm | | | Transverse | 38.09 | 0.6 | Δ |
| | | | | | 11.18 | 11.18 | |

### (4) Discussion

From the results shown in Table 4, although there were some differences in physical properties depending on the type of fibrous material, the evaluation of all examples was within the acceptable range.

### Experimental Example 3

In Experimental example 3, the influence of the difference in the shape and the like of the foam material 1 according to the present technology on the impact properties was examined.

### (1) Manufacturing of Paper Foam Material

By using the materials shown in Table 5 below, the paper foam materials were manufactured in the similar manner as in Experimental example 1, and were processed into the shapes shown in Table 6 below (Samples 9 to 12). As Control, an example using corrugated cardboard used as an existing packing material (Controls 2 to 4) and an example using expanded polystyrene (Control 5) were prepared.

TABLE 5

| | | |
|---|---|---|
| Fibrous material | Type | Waste corrugated cardboard |
| | | (Pre-crushed) |
| | Added | 500 |
| | amount | |
| | (g) | |
| Binder | Type | Polyvinyl alcohol (PVA) |
| | Added | 170 (Water: 2125) |
| | amount | |
| | (g) | |
| Surfactant | Type | Polyoxyethylene alkyl ether |
| | | (“HITENOL” (REGISTERED |
| | | TRADEMARK) Manufactured by |
| | | DKS Co. LTD. ) |
| | Added | 4.5 (Water: 500) |
| | amount | |
| | (g) | |
| Anti-tarnishing | Type | Alum |
| agent | Added | 8.75 (Water: 175) |
| | amount | |
| | (g) | |
| Anti-fungal | Type | Potassium sorbate |
| agent/Antibacterial | Added | 1.7 |
| agent | amount | |
| | (g) | |
| Foam accelerator | Type | Sodium bicarbonate |
| | Added | 25 |
| | amount | |
| | (g) | |
| Softener | Type | Glycerin |
| | Added | 112.5 |
| | amount | |
| | (g) | |
| Carboxylic | Type | Octadecenyl carboxylic |
| | | anhydride |
| anhydride | Added | 78.75 (Water: 436) |
| | amount | |
| | (g) | |

### (2) Evaluation [Cushioning Properties]

Regarding cushioning properties of the manufactured paper foam materials, the cushioning properties were measured in accordance with JIS Z0235.

### [Overall Determination]

⊚: Very good as a heavy object cushioning material
◯: Good as a heavy object cushioning material
Δ: Fair as a light object cushioning material

### (3) Result

The results are shown in Table 6.

TABLE 6

| | | Shape | Cushioning properties | | |
|---|---|---|---|---|---|
| | | (Processing | | σS | |
| | | method) | Cfmin | (Kgf/cm²) | Determination |
| Sample | 9 | Pulp mold | 2.86 to | 0.038 to | ◯ |
| | | (Rounded) *1 + | 2.92 | 0.039 | |
| | | Paper foam | | | |
| | | material | | | |
| | 10 | Pulp mold | 3.13 to | 0.039 to | ◯ |
| | | (Cornered) *2 + | 3.31 | 0.041 | |
| | | Paper foam | | | |
| | | material | | | |
| | 11 | Craft | 4.27 to | 0.032 to | Δ |
| | | honeycomb + | 4.56 | 0.041 | |
| | | Paper foam | | | |
| | | material | | | |
| | 12 | Corrugated | 4.44 to | 0.071 to | Δ |
| | | cardboard | 5.56 | 0.092 | |
| | | honeycomb + | | | |
| | | Paper foam | | | |
| | | material | | | |
| Control | 2 | Embossed | 4.49 to | 0.017 to | Δ |
| | | corrugated | 4.53 | 0.021 | |
| | | cardboard | | | |
| | | material | | | |
| | | (Thick) | | | |
| | 3 | Embossed | 4.79 to | 0.033 to | Δ |
| | | corrugated | 4.82 | 0.034 | |
| | | cardboard | | | |
| | | material | | | |
| | | (Thin) | | | |
| | 4 | Corrugated | 4.14 to | 0.024 to | Δ |
| | | cardboard | 4.18 | 0.025 | |
| | | sheet | | | |
| | 5 | Styrene foam | 0.25 | 0.08 | ⊙ |

*1 Pulp mold having a bottom surface with a rounded shape
*2 Pulp mold having a bottom surface with a square-cornered shape

### (4) Discussion

As shown in Table 6, it has been shown that the paper foam material according to the present technology has cushioning properties equivalent to those of an example using corrugated cardboard which is an existing packing material (Controls 2 to 4) and an example using expanded polystyrene (Control 5).

### Experimental Example 4

The sound absorbing effect in a case where the paper foam material according to the present technology is used as a sound absorbing material was examined.

### (1) Manufacturing of Sound Absorbing Material

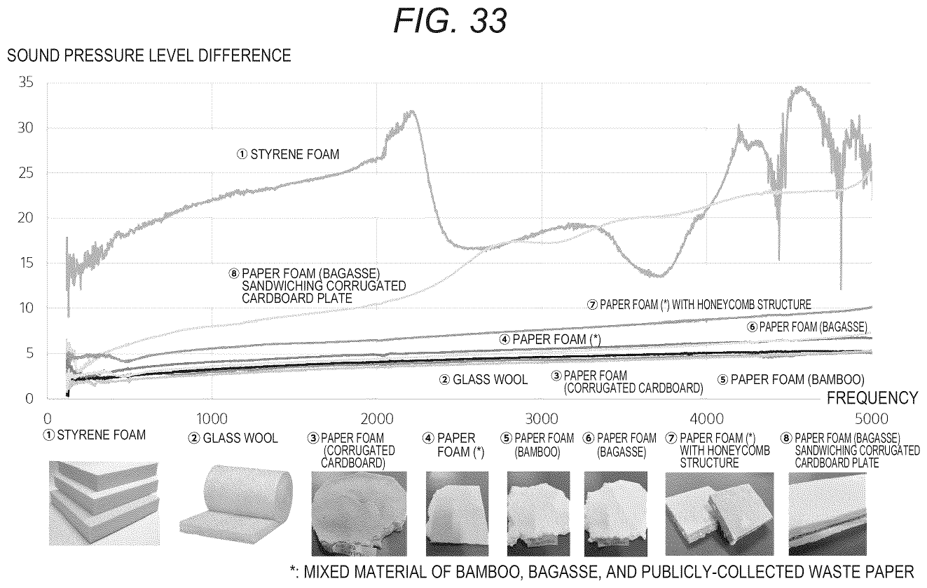

By using the materials shown in Table 7 below and FIG. 33, the paper foam materials were manufactured in the similar manner as in Experimental example 1, and were respectively processed into shapes shown in FIG. 33 to manufacture the sound absorbing materials.

TABLE 7

| | | |
|---|---|---|
| Fibrous material | Type | See FIG. 33 |
| | Added | 500 |
| | amount | |
| | (g) | |
| Binder | Type | Polyvinyl alcohol (PVA) |
| | Added | 170 (Water: 2125) |
| | amount | |
| | (g) | |
| Surfactant | Type | Polyoxyethylene alkyl ether |
| | | (“HITENOL” (REGISTERED |
| | | TRADEMARK) Manufactured |
| | | by DKS Co. LTD.) |
| | Added | 4.5 (Water: 500) |
| | amount | |
| | (g) | |
| Anti-tarnishing | Type | Alum |
| agent | Added | 8.75 (Water: 175) |
| | amount | |
| | (g) | |
| Anti-fungal | Type | Potassium sorbate |
| agent/Antibacterial | Added | 1.7 |
| agent | amount | |
| | (g) | |
| Foam accelerator | Type | Sodium bicarbonate |
| | Added | 25 |
| | amount | |
| | (g) | |
| Softener | Type | Glycerin |
| | Added | 112.5 |
| | amount | |
| | (g) | |
| Carboxylic | Type | Octadecenyl carboxylic |
| anhydride | | anhydride |
| | Added | 78.75 (Water: 436) |
| | amount | |
| | (g) | |

### (2) Evaluation

The manufactured sound absorbing material was subjected to sound transmission loss measurement.

### (3) Result and Discussion

The results are illustrated in FIG. 33. As illustrated in the results of FIG. 33, it has been shown that the paper foam material according to the present technology has sound absorbing performance equivalent to that of glass wool. Furthermore, it has been shown that in a case where a mixed material of bamboo, bagasse, and publicly-collected waste paper was used as a fibrous material or in a case where bagasse was used as a fibrous material, sound absorbing performance was slightly higher than that of glass wool, and sound absorbing performance could be improved to sound absorbing performance equivalent to that of styrene foam by using as a composite material.

### Experimental Example 5

In Experimental example 5, the heat insulating effect in a case where the paper foam material according to the present technology is used as a heat insulating material was examined.

### (1) Manufacturing of Heat Insulating Material

By using the materials shown in Tables 8 and 9 below, the paper foam materials were manufactured in the similar manner as in Experimental example 1. As Controls, styrene foam, glass wool, and cellulose fiber were prepared.

TABLE 8

| | | |
|---|---|---|
| Fibrous material | Type | See Table 9 |
| | Added | 500 |
| | amount | |
| | (g) | |
| Binder | Type | Polyvinyl alcohol (PVA) |
| | Added | 170 (Water: 2125) |
| | amount | |
| | (g) | |
| Surfactant | Type | Polyoxyethylene alkyl ether |
| | | (“HITENOL” (REGISTERED |
| | | TRADEMARK) Manufactured by |
| | | DKS Co. LTD.) |
| | Added | 4.5 (Water: 500) |
| | amount | |
| | (g) | |
| Anti-tarnishing | Type | Alum |
| agent | Added | 8.75 (Water: 175) |
| | amount | |
| | (g) | |
| Anti-fungal | Type | Potassium sorbate |
| agent/Antibacterial | Added | 1.7 |
| agent | amount | |
| | (g) | |
| Foam accelerator | Type | Sodium bicarbonate |
| | Added | 25 |
| | amount | |
| | (g) | |
| Softener | Type | Glycerin |
| | Added | 112.5 |
| | amount | |
| | (g) | |
| Carboxylic | Type | Octadecenyl carboxylic |
| anhydride | | anhydride |
| | Added | 78.75 (Water: 436) |
| | amount | |
| | (g) | |

### (2) Evaluation

The manufactured heat insulating material was subjected to thermal resistance and thermal conductivity measurement.

### (3) Result

The results are shown in Table 9.

TABLE 9

| | | Sample | | | | Control | | |
|---|---|---|---|---|---|---|---|---|
| | | 13 | 14 | 15 | 16 | 6 | 7 | 8 |
| Fibrous Material | | Corrugated | Bamboo | Bagasse | Mixed | Styrene | Glass | Cellulose |
| | | cardboard | | | material of | foam | wool | fiber |
| | | | | | bamboo, | | | |
| | | | | | bagasse, and | | | |
| | | | | | publicly- | | | |
| | | | | | collected | | | |
| | | | | | waste paper | | | |
| Thickness (mm) | | 0.67 | 2.05 | 1.95 | 2.67 | 2.70 | 1.34 | 3.40 |
| Evaluation | Thermal | 0.055 | 0.048 | 0.051 | 0.056 | 0.031 | 0.036 | 0.050 |
| | conductivity | | | | | | | |
| | (W/(m · K) | | | | | | | |

### (4) Discussion

It has been found that Sample 14 using bamboo and Sample 15 using bagasse has a heat insulating effect equivalent or higher than that of cellulose nanofibers. Furthermore, it has been found that Sample 13 using corrugated cardboard and Sample 16 using an original blended material (OBM) have the heat insulating effect slightly less than, but equivalent to that of cellulose nanofibers.

### Experimental Example 6

In Experimental example 6, the flame-proofing/flame retardant effect in a case where the paper foam material according to the present technology is used as flame-proof material/flame retardant material was examined.

### (1) Manufacturing of Flame-Proof Material/Flame Retardant Material

By using the materials shown in Table 10 below, at the time of manufacturing the paper foam materials in the similar manner as in Experimental example 1, the flame-proof materials/flame retardant materials were manufactured by adding a predetermined amount of the flame-proofing agent.

TABLE 10

| | | |
|---|---|---|
| Fibrous material | Type | Pulp |
| | Added | 500 |
| | amount | |
| | (g) | |
| Binder | Type | Polyvinyl alcohol (PVA) |
| | Added | 170 (Water: 2125) |
| | amount | |
| | (g) | |
| Surfactant | Type | Polyoxyethylene alkyl ether |
| | | (“HITENOL” (REGISTERED |
| | | TRADEMARK) Manufactured by |
| | | DKS Co. LTD.) |
| | Added | 4.5 (Water: 500) |
| | amount | |
| | (g) | |
| Anti-tarnishing | Type | Alum |
| agent | Added | 8.75 (Water:175) |
| | amount | |
| | (g) | |
| Anti-fungal | Type | Potassium sorbate |
| agent/Antibacterial | Added | 1.7 |
| agent | amount | |
| | (g) | |
| Foam accelerator | Type | Sodium bicarbonate |
| | Added | 25 |
| | amount | |
| | (g) | |
| Softener | Type | Glycerin |
| | Added | 112.5 |
| | amount | |
| | (g) | |
| Carboxylic | Type | Octadecenyl carboxylic |
| anhydride | | anhydride |
| | Added | 78.75 (Water: 436) |
| | amount | |
| | (g) | |
| Flame-proofing | Type | Aluminum hydroxide |
| agent | Added | See Table 11 |
| | amount | |
| | (g) | |

### (2) Evaluation

### [Flame Retardant Properties]

The manufactured flame extinguishing materials/flame retardant materials were subjected to a flame retardant test in accordance with JIS L1091 A-2 regulation.

### (3) Result

The results are shown in Table 11.

TABLE 11

| Flame-proofing agent | | | Sample | | |
|---|---|---|---|---|---|
| (Added amount with respect to 100 | | | 17 | 18 | 19 |
| parts by mass of fibrous material) | | | 0 | 100 | 200 |
| Flame | Heated for | Afterflame | All | 0 | 0 |
| retardant | 2 minutes | time | burned | | |
| properties | | (seconds) | | | |
| | | Afterflame | All | 0 | 0 |
| | | time + | burned | | |
| | | afterglow | | | |
| | | time | | | |
| | | (seconds) | | | |
| | | Burned area | All | 52 | 18 |
| | | | burned | | |
| | Heated for | Afterflame | All | 3 | — |
| | 6 seconds | time | burned | | |
| | after | (seconds) | | | |
| | catching | Afterflame | All | 4 | — |
| | fire | time + | burned | | |
| | | afterglow | | | |
| | | time | | | |
| | | (seconds) | | | |
| | | Burned area | All | 9 | — |
| | | | burned | | |

### (4) Discussion

As shown in Table 11, it has been shown that, by having the flame-proofing agent contained in the paper foam material according to the present technology, the flame-proofing/flame retardant effect is exhibited.

### Experimental Example 7

In Experimental example 7, an aromatic material/deodorant material was manufactured by using the paper foam material according to the present technology.

### (1) Manufacturing of Aromatic Material/Deodorant Material

By using the materials shown in Table 12 below, at the time of manufacturing the paper foam materials in the similar manner as in Experimental example 1, the aromatic materials/deodorant materials were manufactured by adding a predetermined amount of coffee grounds.

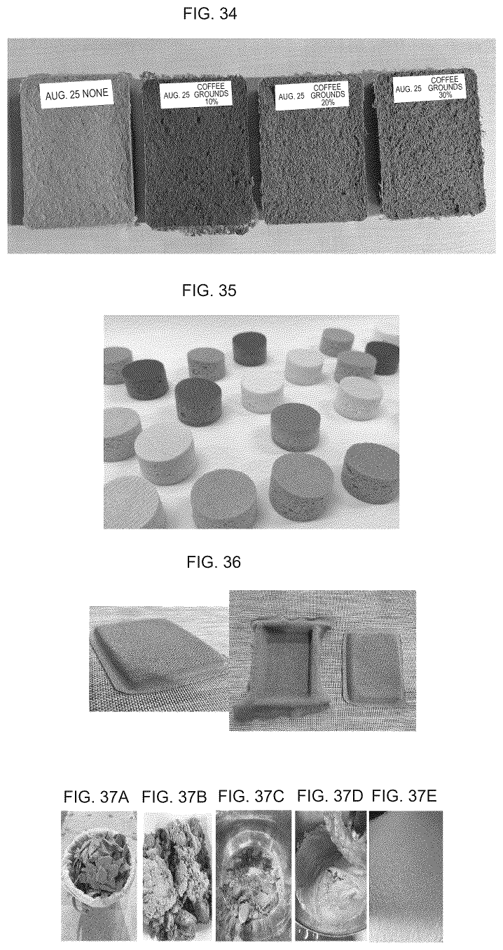

TABLE 12

| | | |
|---|---|---|
| Fibrous material | Type | Pulp |
| | Added | 500 |
| | amount | |
| | (g) | |
| Binder | Type | Polyvinyl alcohol (PVA) |
| | Added | 170 (Water: 2125) |
| | amount | |
| | (g) | |
| Surfactant | Type | Polyoxyethylene alkyl ether |
| | | (“HITENOL” (REGISTERED |
| | | TRADEMARK) Manufactured |
| | | by DKS Co. LTD.) |
| | Added | 4.5 (Water: 500) |
| | amount | |
| | (g) | |
| Anti-tarnishing | Type | Alum |
| agent | Added | 8.75 (Water: 175) |
| | amount | |
| | (g) | |
| Anti-fungal | Type | Potassium sorbate |
| agent/Antibacterial | Added | 1.7 |
| agent | amount | |
| | (g) | |
| Foam accelerator | Type | Sodium bicarbonate |
| | Added | 25 |
| | amount | |
| | (g) | |
| Softener | Type | Glycerin |
| | Added | 112.5 |
| | amount | |
| | (g) | |
| Carboxylic | Type | Octadecenyl carboxylic |
| | | anhydride |
| anhydride | Added | 78.75 (Water: 436) |
| | amount | |
| | (g) | |
| Coffee grounds | Added | See FIG. 34 |
| | amount | |
| | (g) | |

The manufactured aromatic materials/deodorant materials are shown in FIG. 34. As shown in FIG. 34, the aromatic material/deodorant material could be manufactured by using the foam material according to the present technology.

### Experimental Example 8

In Experimental example 8, the paper foam material according to the present technology was subjected to coloring processing.

### (1) Manufacturing of Paper Foam Material

By using the materials shown in Table 13 below, the paper foam materials were manufactured in the similar manner as in Experimental example 1.

TABLE 13

| | | |
|---|---|---|
| Fibrous material | Type | Pulp |
| | Added | 500 |
| | amount | |
| | (g) | |
| Binder | Type | Polyvinyl alcohol (PVA) |
| | Added | 170 (Water:2125) |
| | amount | |
| | (g) | |
| Surfactant | Type | Polyoxyethylene alkyl ether |
| | | (“HITENOL” (REGISTERED |
| | | TRADEMARK) Manufactured by |
| | | DKS Co. LTD. ) |
| | Added | 4.5 (Water: 500) |
| | amount | |
| | (g) | |
| Anti-tarnishing | Type | Alum |
| agent | Added | 8.75 (Water:175) |
| | amount | |
| | (g) | |
| Anti-fungal | Type | Potassium sorbate |
| agent/Antibacterial | Added | 1.7 |
| agent | amount | |
| | (g) | |
| Foam accelerator | Type | Sodium bicarbonate |
| | Added | 25 |
| | amount | |
| | (g) | |
| Softener | Type | Glycerin |
| | Added | 112.5 |
| | amount | |
| | (g) | |
| Carboxylic | Type | Octadecenyl carboxylic |
| | | anhydride |
| anhydride | Added | 78.75 (Water: 436) |
| | amount | |
| | (g) | |
| Coloring agent | Added | Moderate amount |
| | amount | |
| | (g) | |

The manufactured paper foam materials are shown in FIG. 35. As shown in FIG. 35, the paper foam material according to the present technology could be subjected to coloring processing.

### Experimental Example 9

In Experimental example 9, in order to improve the durability of the surface of the paper foam material according to the present technology, a composite material having a surface laminated with a naturally-derived fabric was manufactured.

### (1) Manufacturing of Composite Material

By using the materials shown in the above-described Table 5, the paper foam materials were manufactured in the similar manner as in Experimental example 1. The composite material was manufactured by laminating and integrally attaching the naturally-derived fabric in the foaming step of the paper foam material.

The manufactured composite materials are shown in FIG. 36. As shown in FIG. 36, the paper foam material (composite material) having an improved surface durability could be produced. It is considered that durability, three-dimensional followability by using a single material, decorativeness, and the like can be imparted to the paper foam material according to the present technology by fibers, knitting, weaving, and the like of the fabric. Furthermore, by using a fabric including the same material as the paper foam body, recycling can be facilitated.

### Experimental Example 10

In Experimental Example 10, the manufactured paper foam material was recycled and a paper foam material was manufactured again.

### (1) Recycling Method

The weight of the used paper foam material was measured, and the total amount of fibrous materials was determined from a recipe. The used paper foam material was ground to some extent (see FIGS. 37A to C), then washed with water to be in a fibrous material state, and dehydrated (see FIG. 37D). At this time, in a case where disinfection or sterilization is desired, boiling or high temperature heating (microwave heating or the like) can also be performed. The weight and the amount of moisture of the dehydrated fibrous material were determined, and the fibrous material was mixed with other components with the contents obtained by subtracting the amount of moisture from the paper foam material recipe, a mixed composition was prepared again (see FIG. 37E), and the paper foam material was recycled in the similar manner as in Experimental example 1.

### Experimental Example 11

In Experimental example 11, the paper foam material according to the present technology was subjected to soil reduction.

### (1) Soil Reduction and Plant Growth

### [Soil Reduction]

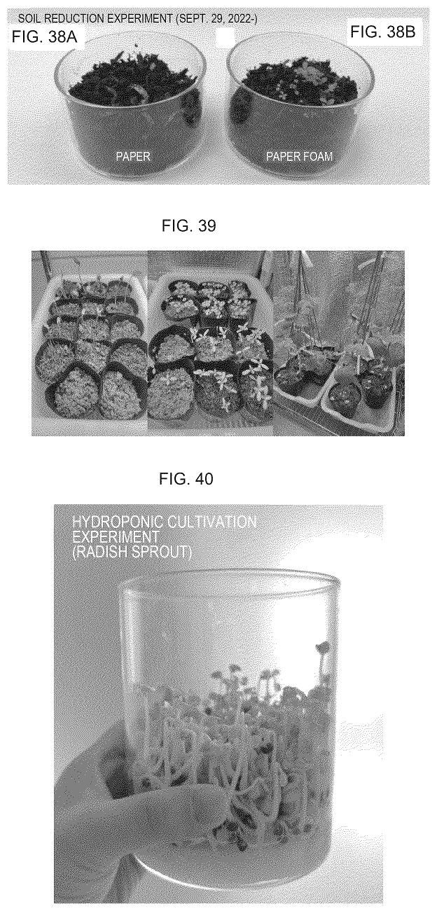

The used paper foam material according to the present technology was mixed into humus, and rehydration and temperature control were appropriately performed, and reduction to soil has been confirmed in about two months. The results are shown in FIG. 38. FIG. 38A shows an example using normal paper, and FIG. 38B shows an example using the paper foam material according to the present technology. As shown in FIG. 38, in the example using the paper foam material according to the present technology, the growth of plants became possible in about two months.

[Plant Growth from Seeds and Seedlings]

The paper foam material was brought into a state close to the state of the fibrous material by water washing, and the growth is performed in accordance with the growing method of each plant while moisture, photosynthesis, temperature, and nutrients are taken into consideration. The results are shown in FIG. 39. As shown in FIG. 39, it has been shown that the plants can be grown by using the paper foam material according to the present technology.

### [Hydroponic Cultivation]

While using a dried paper foam material, a material to be a floor was wetted with moisture and seeds were sown therein, the seeds were rehydrated in a warm dark place for several days, and the seeds were grown while being kept clean, and photosynthesis was carried out along with growth, and the seeds were greened and grown. The results are shown in FIG. 40. As shown in FIG. 40, it has been shown that the plants can be grown by hydroponic cultivation by using the paper foam material according to the present technology.

### [Mushroom Bed Cultivation]

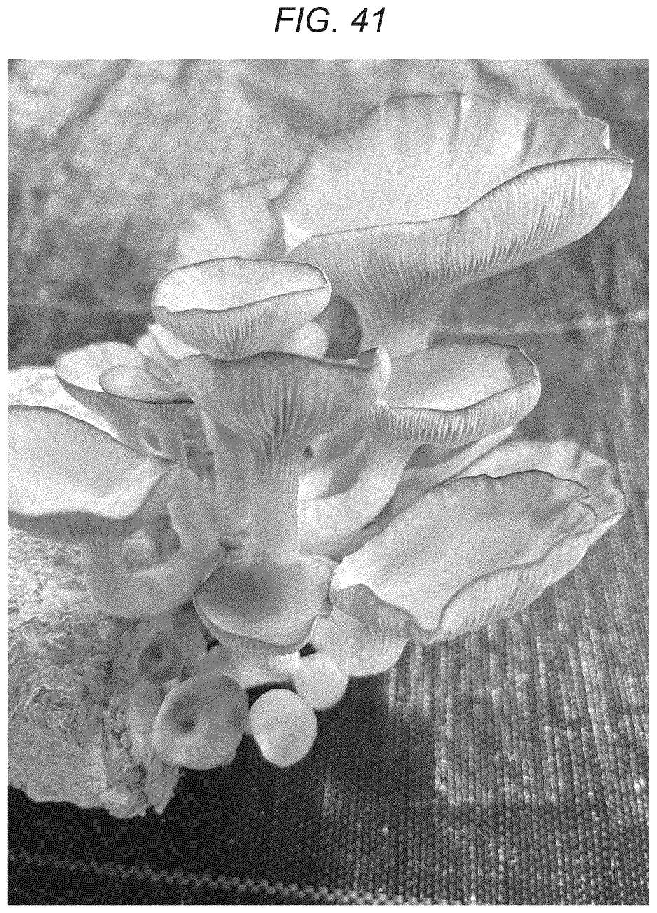

The paper foam material was washed with water and dehydrated to form a fibrous material containing a certain amount of moisture, and then sterilized by using heat, alcohol, and the like. While care is taken to prevent various unwanted bacteria from getting mixed, hyphae were mixed together with a nutrient material (rice bran, wheat bran, tea grounds, food compost, and the like) with a blended amount suitable for bacteria, and the mixture was placed in a sealed container (bottle, bag, box, and the like) provided with a vent that prevents unwanted bacteria from entering, and the bacteria were grown in a dark place at a constant temperature for a certain period of time. After the hyphae has spread over the entire interior of the container, the container was transferred to a bright place and the hyphae was subjected to environmental stimulation such as by being taken out of the container, and being applied with cold water or lowering the outside air temperature and the like. As a result, the fruiting body could be grown in two to three weeks. The results are shown in FIG. 41. As shown in FIG. 41, it has been shown that the plants can be grown by mushroom bed cultivation by using the paper foam material according to the present technology.

### REFERENCE SIGNS LIST

Paper foam material: 1
Base layer: 11
First surface of base layer 11: 111
Second surface of base layer 11: 112
Structural body: 12
Composition: 10
Defibration treatment step: S1
Binder mixing step: S2
Mixing step: S3
Foaming step: S4
Molding step: S5
Drying step: S6, S11, S13
Moisture adding step: S7
Laminating step: S8 (First laminating step)
Embossed sheet: E
Mold: M
Porous sheet: P
Extruder: T
Dryer: H
Applying step: S9
Laminating step: S10 (Second laminating step)
Composite material (Packing material): 2
Base material: 21
Attaching step: S12
Adhesive applying step: S14
Laminating step: S15 (Third laminating step)
Multilayer structure (Packing material): 3
Foam material layer: 31
Adhesive layer: 32

1. A paper foam material comprising:
a fibrous material containing waste paper and/or pulp;
a binder;
sodium hydrogen carbonate; and
a surfactant, and comprising:
a water-soluble softener; and
carboxylic anhydride having a saturated hydrocarbon group and/or an unsaturated hydrocarbon group.

2. The paper foam material according to claim 1, wherein the carboxylic anhydride has a molar ratio of 0.01 to 2 with respect to the softener.

3. The paper foam material according to claim 1, wherein the saturated hydrocarbon group and/or the unsaturated hydrocarbon group has a number of carbon atoms of 12 to 24.

4. The paper foam material according to claim 1, wherein the carboxylic anhydride includes alkenyl carboxylic anhydride.

5. The paper foam material according to claim 4, wherein the alkenyl carboxylic anhydride includes octadecenyl carboxylic anhydride.

6. The paper foam material according to claim 5, wherein the octadecenyl carboxylic anhydride includes octadecenyl succinic anhydride.

7. The paper foam material according to claim 1, wherein the softener includes polyhydric alcohol.

8. The paper foam material according to claim 1, further comprising an anti-tarnishing agent.

9. The paper foam material according to claim 8, wherein the anti-tarnishing agent contains alum.

10. The paper foam material according to claim 1, further comprising an antibacterial agent.

11. The paper foam material according to claim 10, wherein the antibacterial agent contains potassium sorbate.

12. The paper foam material according to claim 1, wherein the binder contains polyvinyl alcohol.

13. The paper foam material according to claim 1, wherein the surfactant contains polyoxyethylene alkyl ether.

14. The paper foam material according to claim 1, wherein the paper foam material has a sheet shape subjected to one or more processing selected from embossing, indenting processing, protruding processing, and hollow processing.

15. The paper foam material according to claim 1, wherein the paper foam material is bonded to a base material with an adhesive layer interposed between the paper foam material and the base material.

16. The paper foam material according to claim 1, wherein the paper foam material is used for one or more applications selected from cushioning material use, packing material use, sound absorbing material use, heat insulating material use, and flame-proof material use.

17. A manufacturing method of a paper foam material, the manufacturing method comprising:
a mixing step of mixing a composition including
a fibrous material containing waste paper and/or pulp,
a binder,
sodium hydrogen carbonate, and
a surfactant, and including
a water-soluble softener, and
carboxylic anhydride having a saturated hydrocarbon group and/or an unsaturated hydrocarbon group; and
a foaming step of foaming the composition.

18. The manufacturing method of the paper foam material according to claim 17, further comprising a molding step of molding the composition by using a mold and/or an embossed sheet.

19. The manufacturing method of the paper foam material according to claim 17, further comprising a drying step of drying the composition after foaming.

20. The manufacturing method of the paper foam material according to claim 19, further comprising a laminating step of laminating the composition after drying on the composition after foaming.

21. The manufacturing method of the paper foam material according to claim 20, further comprising, before the laminating step, a moisture adding step of moistening the composition after drying with a liquid.
